(19) United States
(12) Patent Application Publication
(10) Pub. No.: US 2025/0227738 A1
(43) Pub. Date: Jul. 10, 2025

(54) METHOD AND APPARATUS FOR MULTICARRIER OPERATION

(71) Applicant: INTERDIGITAL PATENT HOLDINGS, INC., Wilmington, DE (US)

(72) Inventors: Tuong Hoang, Montreal (CA); Tao Deng, New York, NY (US); Martino Freda, Laval (CA); Moon IL Lee, Melville, NY (US); Aata El Hamss, Laval (CA)

(73) Assignee: INTERDIGITAL PATENT HOLDINGS, INC., Wilmington, DE (US)

(21) Appl. No.: 18/851,152

(22) PCT Filed: Mar. 30, 2023
(86) PCT No.: PCT/US2023/016880

§ 371 Date: Sep. 26, 2024

Related U.S. Application Data
(60) Provisional application No. 63/327,244, filed on Apr. 4, 2022.

(51) Int. Cl. H04W 72/40; H04W 72/0446; H04W 72/25; H04W 92/18

(52) U.S. Cl. CPC H04W 72/40; H04W 72/0446; H04W 72/25; H04W 92/18

(57) ABSTRACT

A wireless transmit/receive unit (WTRU) may determine to transmit or receive a first sidelink (SL) transmission using first SL resources using a first carrier, and transmit a second SL transmission using second SL resources using a second carrier. The second SL resources may include an overlapping period, in which the second SL resources overlap with the first SL resources. If the overlapping period is in the last one or more symbols of the second SL resources, the WTRU may transmit, using the second carrier, at least part of the second SL transmission using a first set of symbols of the second SL resources in the overlapping period and not transmit, using the second carrier, a part of the second SL transmission using a second set of symbols of the second SL resources in the overlapping period. The WTRU may transmit or receive the first SL transmission in the overlapping period.

### CROSS-REFERENCE TO RELATED APPLICATION

This application claims the benefit of U.S. Provisional Application No. 63/327,244, filed Apr. 4, 2022, the contents of which are incorporated herein by reference.

### BACKGROUND

Both Long-Term Evolution (LTE) V2X and New Radio (NR) V2X operations have been developed. V2X communications may include one or more of vehicle-to-vehicle (V2V) communications, vehicle-to-pedestrian (V2P) communications, vehicle-to-infrastructure (V2I) communications and Vehicle-to-Network (V2N) communications. V2X wireless transmit receive units (WTRUs) may engage in V2X communications.

Third Generation Partnership Project (3GPP) specifications for LTE V2X technologies support sidelink multicarrier operation, which includes, for example: Packet Data Convergence Protocol (PDCP) duplication and transmissions using carrier aggregation, and carrier selection and (re)selection based on a measured channel busy ratio (CBR). The LTE multi-carrier transmission may apply only to broadcast transmissions and the functionalities may be specified within the radio resource control (RRC) and the medium access control (MAC) layers.

LTE V2X may support one subcarrier spacing (SCS) of 15 KHz for all carriers. For carrier aggregation, it may be expected that all the aggregated carriers have the same synchronization configuration. Specifically, all carriers may have the same configured synchronization offset, synchronization periodicity, and number of synchronization occasions per synchronization period. Moreover, all the aggregated carriers may be expected to use the same synchronization source and to be synchronous in both transmission and reception. For synchronization transmission, a WTRU may be preconfigured to transmit a sidelink synchronization signal (SLSS) in one predefined carrier or all aggregated carriers configured for synchronous carrier aggregation.

On the other hand, besides supporting broadcast transmissions, 3GPP release 16 (R16) NR specifications for V2X may support groupcast and unicast transmissions. To support hybrid automatic repeat request (HARQ) based transmissions for groupcast/unicast in sidelink communication, a feedback channel (e.g., a physical sidelink feedback channel (PSFCH)) may be designed to convey HARQ feedback information (e.g., acknowledgement (ACK)/negative ACK (NACK)).

### SUMMARY

Methods and apparatuses for multicarrier operation are provided herein. A wireless transmit/receive unit (WTRU) may determine to transmit or receive a first sidelink (SL) transmission using first SL resources using a first carrier, and to transmit a second SL transmission using second SL resources using a second carrier. In an example, the second SL resources may include an overlapping period. Further, the second SL resources may overlap with the first SL resources in the overlapping period. If the overlapping period is in the last one or more symbols of the second SL resources, the WTRU may transmit, using the second carrier, at least part of the second SL transmission in a first set of symbols of the second SL resources in the overlapping period and not transmit, using the second carrier, in a second set of symbols of the second SL resources in the overlapping period. Further, the WTRU may transmit or receive the first SL transmission using the first SL resources using the first carrier in the overlapping period.

In an example, the first SL resources may include first time resources, and the second SL resources may include second time resources. Also, the overlapping period may be in one or more symbols of the second time resources which overlap in time with one or more symbols of the first time resources.

Further, the first SL transmission may be a physical sidelink feedback channel (PSFCH) transmission. Also, the first SL resources may be PSFCH resources.

Further, the second SL transmission may be a physical sidelink control channel (PSCCH) transmission. Also, the second SL transmission may be a physical sidelink shared channel (PSSCH) transmission. Moreover, the second SL transmission may be a combination of a PSCCH transmission and a PSSCH transmission. In addition, the second SL resources may be PSCCH resources. Also, the second SL resources may be PSSCH resources. Moreover, the second SL resources may be a combination of PSCCH resources and PSSCH resources.

In another example, the transmitting, using the second carrier, at least part of the second SL transmission in a first set of symbols of the second SL resources in the overlapping period and not transmitting, using the second carrier, in a second set of symbols of the second SL resources in the overlapping period may be considered to be puncturing. Additionally or alternatively, the transmitting, using the second carrier, at least part of the second SL transmission in a first set of symbols of the second SL resources in the overlapping period and not transmitting, using the second carrier, in a second set of symbols of the second SL resources in the overlapping period may be considered to be rate matching.

Additionally or alternatively, if the overlapping period is earlier than the last one or more symbols of the second SL resources, the WTRU may dropping the transmission or the reception of the first SL transmission, or drop the transmission of the second SL transmission, based on a comparison of a priority associated with the first SL resources with a priority associated with the second SL resources. In a further example, the WTRU may transmit, to a reception WTRU, information regarding the first set of symbols of the second SL resources and the second set of symbols of the second SL resources in sidelink control information (SCI).

Further, the WTRU may receive an SL grant of resources for transmitting the second SL transmission using the second carrier. Additionally or alternatively, the WTRU may select resources for transmitting the second SL transmission using the second carrier.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a resource diagram illustrating two typical example scenarios in which a WTRU performs resource prioritization;

FIG. 3 is a resource diagram illustrating an example scenario of physical sidelink feedback channel (PSFCH) carrier selection for simultaneous PSFCH transmission;

FIG. 4 is a resource diagram illustrates an example procedure performed by a WTRU for prioritization between PSFCH resources and physical sidelink control channel (PSCCH) or physical sidelink shared channel (PSSCH) resources;

FIG. 5 is a flowchart diagram illustrating an example of prioritization between PSFCH resources and PSCCH/PSSCH resources;

FIG. 6 is a flowchart diagram illustrating an example of prioritization between a first sidelink (SL) transmission and a second SL transmission;

FIG. 7 is a resource diagram illustrating an example of a WTRU excluding the PSCCH/PSSCH resources overlapping with a scheduled PSFCH transmission/reception;

FIG. 8 is a resource diagram illustrating an example of a WTRU excluding the PSCCH/PSSCH resources having an associated PSFCH transmission/reception overlapping with the scheduled/reserved resource from another carrier;

FIG. 9 is a resource diagram illustrating an example of a WTRU performing resource reselection when the PSCCH/PSSCH resources and/or its associated PSFCH resources overlap with the reception resources in another carrier;

FIG. 10 is a resource diagram illustrating example scenarios in which a WTRU determines whether to perform resource reselection or other prioritization methods due to resources overlapping in different carriers; and

FIG. 11 is a resource diagram illustrating an example scenario of a WTRU determining the sidelink synchronization signal (SLSS) occasion in which to transmit an SLSS.

### DETAILED DESCRIPTION

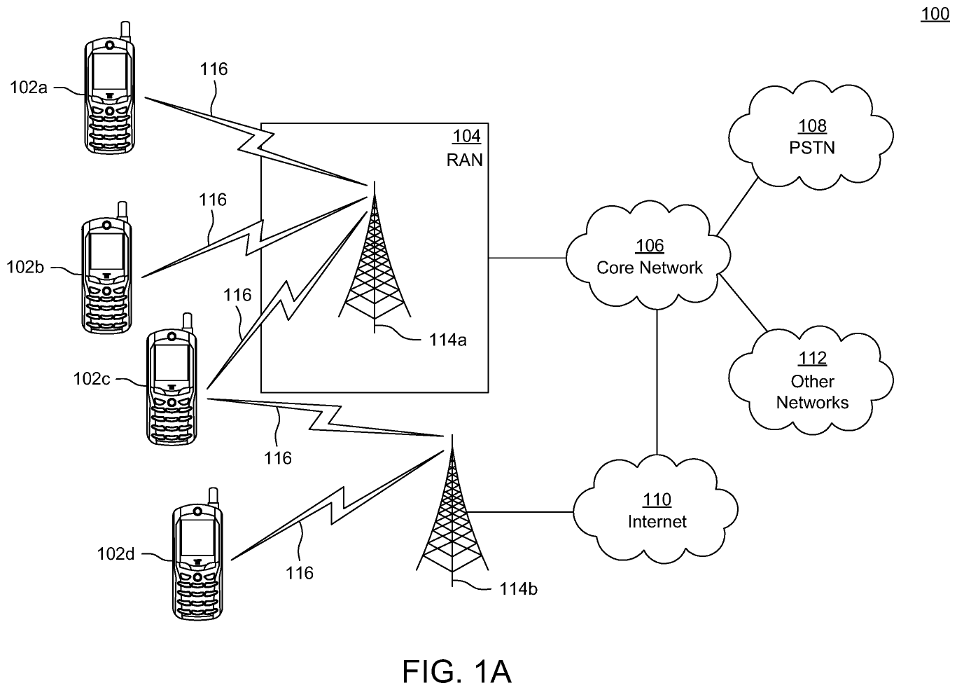

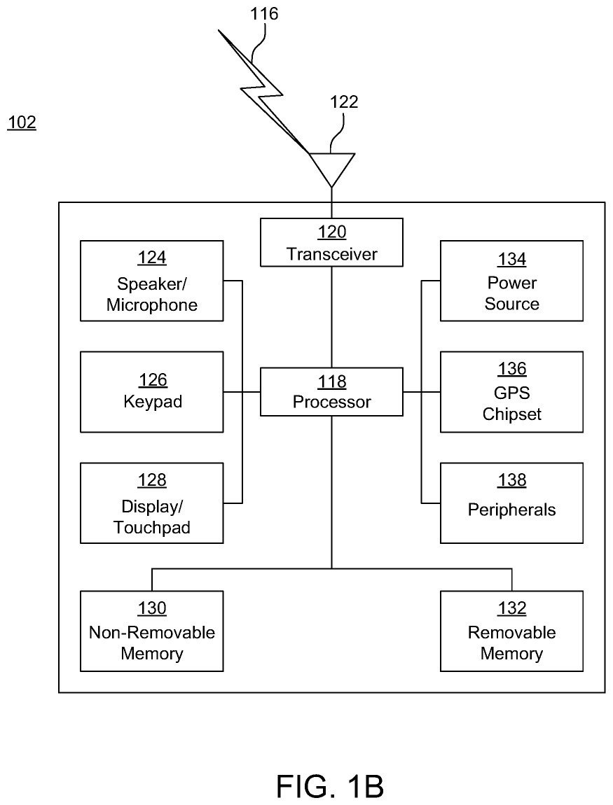

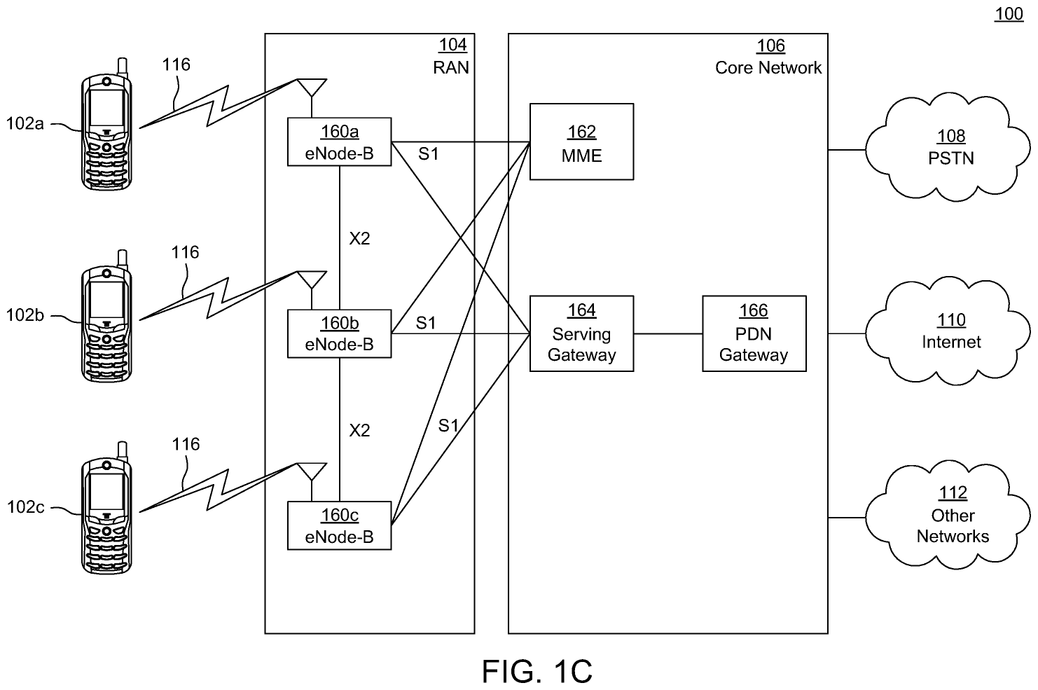

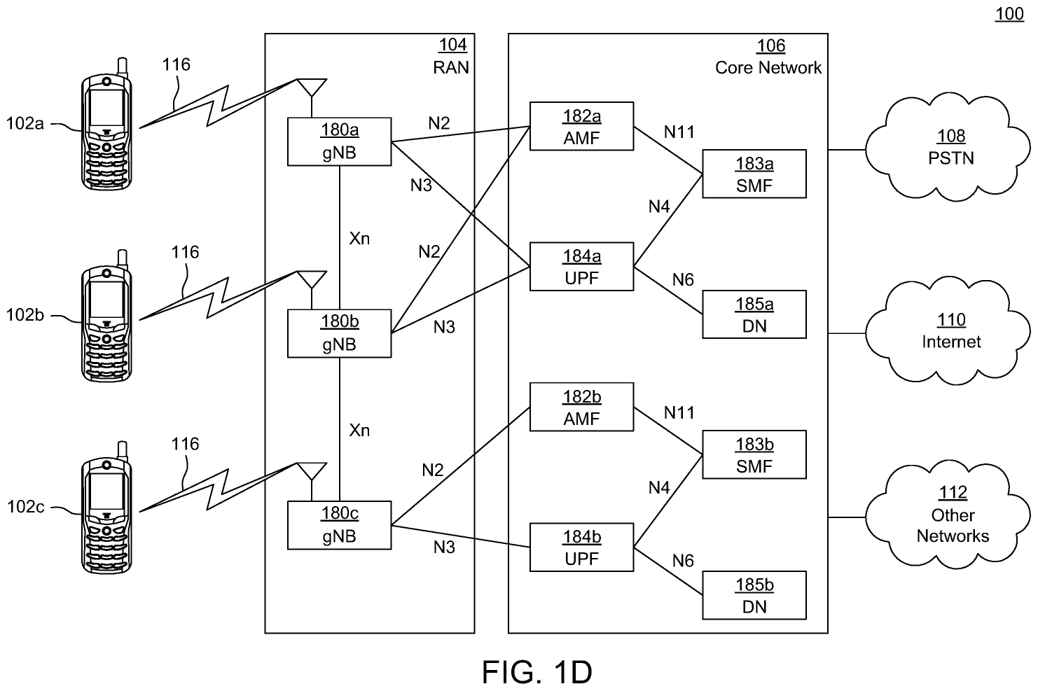

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

NR V2X may use broadcast, groupcast and unicast transmissions. To support hybrid automatic repeat request (HARQ) based transmissions for groupcast/unicast in sidelink communication, a feedback channel, such as a physical sidelink feedback channel (PSFCH), may be designed to convey HARQ feedback information, such as, acknowledgement (ACK)/negative ACK (NACK).

A sidelink resource pool, which may include a contiguous number of subchannels periodically repeated in the time domain. A PSFCH transmission may be placed at the end of a slot if the slot is configured for PSFCH transmission/reception. If one or more PSFCH transmissions are configured in a resource, a WTRU may be configured with PSFCH occasions every 1, 2, or 4 slots, for example.

A one-to-one mapping between a physical sidelink control channel (PSCCH) or physical sidelink shared channel (PSSCH) and PSFCH(s) may be established in the resource pool such that the transmitting (Tx) WTRU of the HARQ feedback may be aware of the time, frequency, and code resource to transmit HARQ feedback for a given PSCCH/PSSCH reception and the Tx WTRU of the PSCCH/PSSCH may not need to perform blind detection of the HARQ feedback channel of its transmitted PSCCH/PSSCH resource. The mapping between the PSCCH/PSSCH and PSFCH resources may be configured such that the time gap between two resources may be greater than or equal to K logical slots in the resource pool. K may be configured or preconfigured in the resource pool between two and three slots.

The WTRU may transmit multiple PSCCH/PSSCH transmissions to two different destinations with HARQ feedback enabled in a short period and may be expected to receive multiple PSFCHs in the same slot, in which each PSFCH may be associated with a PSCCH/PSSCH transmission. A WTRU, receiving multiple PSCCH/PSSCHs from the same or different transmitter WTRUs in a short period, may be expected to perform simultaneous PSFCH transmission(s) in the same slots.

Simultaneous transmission or reception of PSFCH transmissions may be supported in R16 NR V2X. According to some WTRU capabilities, a WTRU may perform simultaneous reception of a certain number of PSFCH transmissions and concurrent transmissions on a certain number of PSFCHs. Simultaneous PSFCH transmissions in one carrier may be carefully designed in R16 NR V2X to guarantee the reliability of HARQ feedback and reduce HARQ dropping.

R16 NR V2X may support various subcarrier spacings (SCSs) for each carrier, which may vary from 15 KHz to 120 KHz. Regarding synchronization configuration for each carrier, it may be expected that all carriers may have the same synchronization periodicity (e.g., 160 ms). However, the synchronization offset and the number of synchronization occasions per synchronization period may vary according to the SCS and the frequency of the carrier.

In the development of release 18 (R18) Sidelink Evolution (SLE), studies may be underway regarding carrier aggregation (CA), in which R15 LTE V2X CA may be taken as a baseline. Modification to wireless communications may include support for LTE sidelink CA features for NR and future technologies that may include synchronization of aggregated carriers, handling of limited capabilities, and power control for simultaneous sidelink transmission (TX).

Different from LTE V2X, modification to wireless communications may include multicarrier operation using carriers having the same or different SCSs, different PSFCH, and/or synchronization configurations. Sidelink communication may be established in different bands, which may include the full-duplex and half-duplex bands. For half-duplex bands, a WTRU may not expect to perform simultaneous transmission and reception in different carriers within the band regardless of the number of transceiver (TRX) chains.

Further modification to wireless communications may include a newly introduced channel in NR (e.g., PSFCH) and different transmission duration(s) over various transmission channels (e.g., PSCCH/PSSCH, PSFCH) or one channel in different carriers with different SCSs. Therefore, handling of limited WTRU capabilities may require a proper resource allocation and resource prioritization scheme to reduce resource collision and dropping. Moreover, modified wireless communications may also be expected to aggregate multiple carriers with various synchronization configurations due to operation band and the desired latency of packet delivery (e.g., the network may configure a larger SCS for targeting the lower latency requirement services). Therefore, synchronization procedures may need to be investigated to address such different synchronization configurations.

Various solutions to the above-described problems are described herein. As used herein, the phrases “a WTRU may be configured with” something, “a WTRU may be configured with” something, and “a WTRU may be (pre-)configured with” something may be equivalent or can be used interchangeably with the phrase “a WTRU receives a configuration from another node (e.g., gNB) of” something and still remain consistent with the examples and embodiments provided herein.

As described herein, an overlapping region between two resources in the time domain may include the actual overlapping symbols and the WTRU's processing time for transition to process two resources, such as, for example, Tx/Rx switching time, automatic gain control (AGC) setting time, etc.

As used herein, the terms resource allocation, pre-emption, and resource re-evaluation may be used interchangeably, and may be used to describe a procedure to identify whether a preselected resource or a reserved resource is still available and/or identify the available resources for transmission by performing due to sensing and extracting the sensing result. If not stated otherwise, resource allocation may mean an initial resource allocation, pre-emption, and/or resource re-evaluation, for example. In the description herein, the term “carrier” is used throughout. However, “carrier” may be used interchangeably or may be equivalent to “BWP”, “resource pool”, or “Radio Access Technology (RAT)” and still be consistent with the embodiments and examples provided herein. The terms “colliding” and “overlapping” may be used interchangeably and still be consistent with the embodiments and examples provided herein.

As used herein, the term resource may refer to a single resource or may be considered to refer to multiple resources and still be consistent with the embodiments and examples provided herein. Likewise, the term resources may refer to multiple resources or may be considered to refer to a single resource and still be consistent with the embodiments and examples provided herein. Further, the phrases “using resources” and “on resources” may be used interchangeably and still be consistent with the embodiments and examples provided herein. Similarly, “using a carrier” and “on a carrier” may be used interchangeably and still be consistent with the embodiments and examples provided herein.

Further, as used herein, a PSCCH/PSSCH transmission may refer to any one of a PSCCH transmission, a PSSCH transmission, or a combination of a PSCCH transmission and a PSSCH transmission, and these terms may be used interchangeably and still be consistent with the embodiments and examples provided herein. Likewise, PSCCH/PSSCH resources may refer to any one of PSCCH resources, PSSCH resources, or a combination of PSCCH resources and PSSCH resources, and these terms may be used interchangeably and still be consistent with the embodiments and examples provided herein. As used herein, resources may include any one of one or more time resources, one or more frequency resources, or a combination of one or more time resources and one or more frequency resources.

Methods for resource prioritization among multiple resources are described herein. In some solutions, a WTRU may prioritize transmission/reception resources.

In some solutions, a WTRU may determine whether to perform prioritization among multiple resources, which may be transmission and/or reception resources. In some examples, the WTRU may perform prioritization among multiple transmission resources due to one or any combination of the following conditions: a number of TX chains is smaller than the number of transmission carriers; the WTRU does not support the band combination in the scheduled resources; the WTRU TX chain switching time of the WTRU is not satisfied to transmit in multiple carriers; the WTRU may not fulfill an RF requirement, e.g., due to power spectral density (PSD) imbalance; or the transmission power of the WTRU exceeds the maximum allowed power.

In some examples, the WTRU may perform prioritization between transmission and reception resources due to one or any combination of the following conditions: a number of TRX chains is smaller than the number of transmission/reception carriers; the WTRU operates in a half-duplex band, which may not allow the WTRU to perform simultaneous transmission and reception; or the Tx/Rx switching time of the WTRU is not satisfied to transmit in one carrier and receive in another carrier.

In some examples, the WTRU may perform prioritization between reception resources due to one or any combination of the following conditions: the number of receiving (RX) chains is smaller than the number of reception carriers; the number of reception channels exceeds the WTRU capability; or the RX switching/retuning time of the WTRU is not satisfied to receive in multiple carriers.

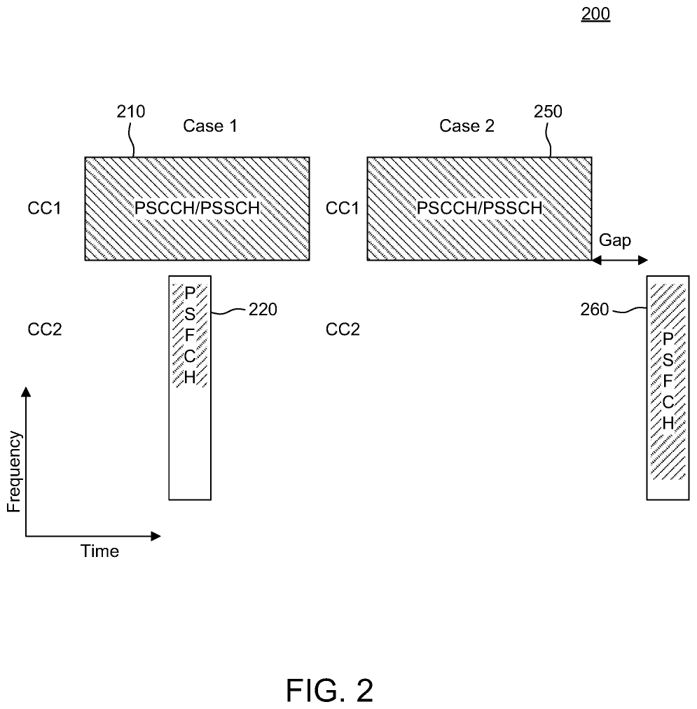

FIG. 2 is a resource diagram illustrating two typical example scenarios in which a WTRU performs resource prioritization. In an example shown in resource diagram 200, the WTRU may perform prioritization between two resources for transmission and/or reception in two carriers in two cases. In a first case, such as Case 1, the WTRU may perform prioritization if the two transmission/reception resources are overlapped. Specifically, the WTRU may perform resource prioritization if the PSCCH/PSSCH resources 210 are overlapped with the PSFCH resources 220. In an example, the overlapped resources may be time resources. In a second case, such as Case 2, the two resources are not overlapped. The WTRU may perform resource prioritization if the time gap between the end of the first resources, such as PSCCH/PSSCH resources 250, and the start of the second resources, such as PSFCH resources 260, is smaller than a determined threshold. The determined threshold may be fixed, configured in the resource pool, preconfigured in the resource pool, and/or based on the WTRU capability. For example, if the WTRU has one TRX chain, the determined threshold may be at least one symbol. However, if the WTRU has two TRX chains, the determined threshold may be much less than one symbol time since the WTRU may not need to do Tx/Rx switching.

In some solutions, a WTRU may perform prioritization among transmission and/or reception resources. Specifically, the WTRU may determine to perform prioritization among two or more resources for transmission and/or reception resources. The WTRU may perform one or any combination of the following procedures for prioritization among resources.

In some examples, the WTRU may drop one or multiple resources. Dropping one transmission resource may herein refer to not performing transmission in the resource. Dropping one reception resource may herein refer to not performing reception in the resource. For example, the WTRU may determine to drop and/or not to perform transmission/reception in one or multiple non-prioritized resources. Also, the WTRU may determine to perform transmission/reception in one or more prioritized resources.

In some examples, the WTRU may reduce transmission power of one or multiple resources. For example, the WTRU may be configured or preconfigured with one or more parameters to determine/calculate the transmission power of one or more resources. The WTRU may then determine to reduce the transmission power of one or more non-prioritized resources compared to the calculated/determined/configured transmission power. The WTRU may determine to keep the same power of one or more prioritized transmission resources.

In some examples, the WTRU may increase the transmission power of one or multiple resources. For example, the WTRU may be configured or preconfigured with one or more parameters to determine/calculate the transmission power of one or more resources. The WTRU may then determine to increase the transmission power of one or more prioritized resources compared to the calculated/determined/configured transmission power.

In some examples, the transmission WTRU may perform rate-matching or puncturing one transmission resource. Puncturing and/or rate-matching of a symbol herein may be referred to as not sending or not receiving signals in the symbol. The transmission WTRU may then implicitly/explicitly indicate, for example, in sidelink control information (SCI), to the reception WTRU of its puncturing and/or rate-matching. This approach may be motivated to help the receiver WTRU in decoding the rate-matched/punctured transmission. For example, the WTRU may determine to rate match or puncture one or more symbols for one or more non-prioritized resources, which may be overlapped with the prioritized resource or which may have the time gap with the start of the prioritized resource being smaller than a time gap threshold, in which the threshold may be fixed, configured in the resource pool, preconfigured in the resource pool, and/or may be based on the WTRU capability. In an example, the WTRU capability may be a Tx/Rx switching capability.

In some examples, the WTRU may perform transmission only. For example, the WTRU may need to perform prioritization between two sets of resources, in which one set may be used for transmission and another set may be used for reception. The WTRU may then determine to prioritize the transmission resource. The WTRU may then determine to perform transmission only.

In some examples, the WTRU may perform reception only. For example, the WTRU may need to perform prioritization between two sets of resources, in which one set may be used for transmission and another set may be used for reception. The WTRU may then determine to prioritize the reception resource. The WTRU may then determine to perform reception only. The WTRU may determine not to perform transmission in the non-prioritized resource.

In some examples, the WTRU may perform resource reselection for one or more transmission resources. For example, the WTRU may need to prioritize between two resources, in which at least one resource may be used for transmission. If the transmission resource is deprioritized, the WTRU may then determine to perform resource reselection for the transmission resource. For example, the WTRU may detect potential collision between one transmission resource, for example, a PSCCH/PSSCH resource, in one carrier and transmission/reception resource in another carrier, for example, a PSCCH/PSSCH resource, and the WTRU may trigger resource reselection for the transmission resource in the first carrier.

In some examples, the WTRU may trigger one or more inter-UE coordination (IUC) transmissions. For example, the WTRU may select/reserve or be scheduled one transmission/reception resource in one carrier. The WTRU may receive an SCI from another WTRU scheduling/reserving a transmission resource in another carrier which may overlap with the WTRU's selected/reserved/scheduled transmission/reception resource. The WTRU may then trigger sending an IUC transmission, including, for example, a scheme 2 collision indication, to the peer WTRU to indicate the potential collision. The WTRU may expect the receiver of the IUC to reselect the resource to avoid resource collision.

In some solutions, a WTRU may determine which procedure to perform for resource prioritization. The WTRU may determine which procedure and/or which combination of procedures to perform to prioritization among multiple resources based on one or any combination of parameters as described in the following examples.

For example, the WTRU may determine which procedure and/or which combination of procedures for perform to prioritization among multiple resources based on a WTRU capability. For example, if the WTRU is configured to transmit and/or receive in multiple carriers, the WTRU may determine to perform transmission and/or reception in all carriers if the number of TRX chains is larger than the number of configured carriers. The WTRU may perform power reduction of one or more non-prioritized carriers if the transmission in all carriers exceeds the maximum limit. Otherwise, if the number of TRX chains is smaller than the number of configured carriers, the WTRU may determine to drop the transmission/reception resource in one or more carriers.

For example, the WTRU may determine to transmit in multiple carriers if the WTRU supports the band combination. The WTRU may then perform power reduction for one or more carriers if the transmission in all carriers exceeds the maximum limit. Otherwise, if the WTRU does not support the band combination the WTRU may determine to drop the transmission/reception resource in one or more carriers.

For example, the WTRU may puncture/rate-match in the overlapping symbols between two resources of the two carriers if the WTRU is not able to transmit simultaneously in two carriers. Otherwise, if the WTRU determines to transmit in two carriers, the WTRU may reduce the transmission power of a non-prioritized resource.

In a further example, the WTRU may determine which procedure and/or which combination of procedures to perform for prioritization among multiple resources based on the type of channel used for transmission, reception or both. In examples, the channel used may be one or any combination of a PSFCH, PSCCH/PSSCH, or physical sidelink broadcast channel (PSBCH).

For example, if the WTRU is not capable of simultaneous transmission and/or reception in two resources, the WTRU may determine whether to drop resources in one carrier or conduct rate-matching/puncturing of the non-prioritized resource based on the type of channel used for transmission, reception or both. For example, the WTRU may determine to drop one resource if the two colliding resources are PSCCH/PSSCH resources. The WTRU may determine to rate-match/puncture the PSCCH/PSSCH transmission around the colliding region between the PSFCH resources and PSCCH/PSSCH resources.

In a further example, the WTRU may determine which procedure and/or which combination of procedures to perform for prioritization among multiple resources based on the duration of transmission for each resource, the duration of reception for each resource, or both. For example, if the transmission/reception duration of one resource is smaller than a threshold, the WTRU may perform either dropping or power reduction if the resource is deprioritized. Otherwise, if the transmission/reception duration of the resource is larger than the threshold, the WTRU may perform puncturing/rate-matching, dropping, and/or power reduction if the resource is non-prioritized.

In a further example, the WTRU may determine which procedure and/or which combination of procedures to perform for prioritization among multiple resources based on the overlapping region between two resources. For example, in case the WTRU determines not to perform simultaneous transmission in two carriers, the WTRU may determine to drop the resource in one carrier if the overlapping duration between two resources is greater than a threshold; otherwise, if the overlapping duration between two resources is smaller than the threshold, the WTRU may puncture/rate-match the non-prioritized resource.

For example, the WTRU may determine to perform rate-matching/puncturing of one resource if the overlapping region belongs to the last slot(s) of one resource and at the initial slot(s) of another resource. The WTRU may drop one of the resources if the overlap region between two resources is in the middle of one resource, which may require the WTRU to resume transmission after the resource is punctured/rate-matched.

In some examples, the WTRU may determine which procedure and/or which combination of procedures to perform for prioritization among multiple resources based on a number of resources/channels to transmit and/or receive in one or more carriers. For example, the WTRU may perform power reduction if the number of dropped resources in one carrier is greater than a threshold. Otherwise, if the number of dropped resources is smaller than the threshold, the WTRU may perform resource dropping. The threshold may be configured or preconfigured in the resource pool.

In some examples, the WTRU may determine which procedure and/or which combination of procedures to perform to prioritization among multiple resources based on a QoS (e.g., priority, reliability, and/or latency requirement) associated with the transmission and/or reception resource. For example, the WTRU may determine whether to perform dropping based on the QoS (e.g., priority) of the resource. Specifically, if the priority of the non-prioritized resource is smaller than a threshold, the WTRU may determine to drop the resource. Otherwise, if the priority of the non-prioritized resource is larger than the threshold, the WTRU may not perform resource dropping. Specifically, if the priority of the resource is greater than the threshold, the WTRU may perform power reduction and/or rate-matching/puncturing of the resource.

In some examples, the WTRU may determine which procedure and/or which combination of procedures to perform to prioritization among multiple resources based on a synchronization status between two carriers. For example, the WTRU may perform dropping one resource if the two carriers associated with the two resources are asynchronous. Otherwise, if the two carriers are synchronized, the WTRU may perform puncturing and/or rate matching of one resource.

In some examples, the WTRU may determine which procedure and/or which combination of procedures to perform to prioritization among multiple resources based on a time gap between the prioritization event and the potential resource collision time. For example, the WTRU may perform resource reselection if the time gap between the prioritization event and the potential resource collision time is larger than a threshold. The threshold may be configured or preconfigured in the resource pool. The threshold may be determined based on the WTRU capability. Otherwise, if the time gap between the prioritization event and the potential resource collision time is smaller than the threshold, the WTRU may perform other prioritization procedures such as dropping, reducing transmission power, and/or rate-matching/puncturing of one resource.

Furthermore, in some examples, the WTRU may perform puncturing/rate-matching of one deprioritized resource (e.g., PSCCH/PSSCH) if the time gap between the prioritization event and the potential resource collision is within a range (e.g., smaller than one threshold and larger than another threshold). Otherwise, if the time gap between the prioritization event and the potential resource collision is outside of the range, the WTRU may perform other prioritization procedures such as dropping one resource or performing resource reselection for one resource.

In some embodiments as may be described herein, a WTRU may determine which resource to prioritize. For instance, the WTRU may perform prioritization between two resources in the same or different carriers. The WTRU may determine which resource to prioritize based on one or any combination of parameters as described in the following examples.

The WTRU may determine which resource to prioritize based on a physical channel transmission transmitted in the resource. For example, the WTRU may prioritize a sidelink (SL) synchronization signal block (SSB) (SL-SSB) over other channels. For example, the WTRU may prioritize SL-SSB transmission in one carrier over the transmission/reception of signals in other channels in another carrier. For example, the WTRU may prioritize other channel reception/transmission (e.g., PSFCH) in one carrier over SL-SSB reception in another carrier. Additionally or alternatively, the WTRU may prioritize PSFCH transmission/reception over other channels except for SL-SSB.

The WTRU may determine which resource to prioritize based on the information conveyed in the transmission. The information conveyed in the PSFCH may be the IUC information, ACK indication, NACK indication for NACK-groupcast, NACK indication for unicast. In some approaches, the WTRU may determine which resource to prioritize based on the information conveyed in the resource. In another approach, similar to the existing prioritization scheme, the WTRU may first determine which resource to prioritize based on the priority associated with the resource. However, if the two resources have the same priority, the WTRU may then prioritize one resource over another resource based on the information conveyed in the resource. For example, the WTRU may prioritize the PSCCH/PSSCH over other channels (e.g., other PSCCH/PSSCH, PSFCH, and the like) if the PSCCH/PSSCH has one or more SL channel state information (CSI) reference signals (RSs) (SSL-CSI-RS(s)).

In some examples, the WTRU may determine whether to prioritize the PSCCH/PSSCH or PSFCH based on the information conveyed in the PSFCH. For example, the WTRU may prioritize the PSCCH/PSSCH over the PSFCH if the PSFCH conveys IUC information. However, the WTRU may prioritize the PSFCH over the PSCCH/PSSCH if the PSFCH conveys HARQ feedback information.

The WTRU may determine which resource to prioritize based on the carrier associated with each resource. For example, the WTRU may determine which resource to prioritize based on the resource pool associated with each resource. In one approach, the WTRU may be configured or preconfigured with a priority associated with each carrier. In another approach, the WTRU may be configured or preconfigured between two carriers based on which one has higher priority. The WTRU may then determine which resource to prioritize based on the carrier associated with the resource. The WTRU may first determine which resource to prioritize based on the priority associated with each resource. If the two resources have the same priority, the WTRU may then determine which resource to prioritize based on which carrier has higher priority. The WTRU may prioritize the resource in the carrier having higher priority.

The WTRU may determine which resource to prioritize based on the type of carrier associated with each resource. For example, the WTRU may prioritize the resource in the shared carrier with Uu carriers. The WTRU may prioritize the resource in the licensed carrier.

The WTRU may determine which resource to prioritize based on the scheduling mode of the resource and/or the scheduling mode associated with the resource. For example, the WTRU may prioritize the resource or the associated resource (e.g., PSFCH) scheduled by the network compared to the resource selected by the WTRU.

The WTRU may determine which resource to prioritize based on the transmission power associated with each resource. In one approach, the WTRU may prioritize the resource having higher transmission power. In another approach, the WTRU may prioritize the resource having lower transmission power.

The WTRU may determine which resource to prioritize based on the transmission/reception duration of each resource. In some approaches, the WTRU may prioritize the resource having a longer transmission/reception duration. In another approach, the WTRU may prioritize the resource having a shorter transmission/reception duration.

The WTRU may determine which resource to prioritize based on the subcarrier spacing associated with the resource. In some approaches, the WTRU may prioritize the resource having the longer subcarrier spacing. In another approach, the WTRU may prioritize the resource having shorter subcarrier spacing.

In a further example, the WTRU may determine which resource to prioritize based on the number of occupied resources in the time and/or frequency domain. For example, the WTRU may determine which resource to prioritize based on the number of resources of the resource. In an example, the number of resources may include a number of subchannels. Additionally or alternatively, the number of resources may include a number of resource elements (REs). In one approach, the WTRU may prioritize the resource occupying a larger number of resources. In another approach, the WTRU may prioritize the resource occupying a smaller number of resources.

The WTRU may determine which resource to prioritize based on the number of physical channels (e.g., PSFCH, PSCCH/PSSCH) in each resource. Specifically, the WTRU may prioritize the resource(s) having a higher number of physical channels. For example, the WTRU may need to prioritize between PSFCH transmission/reception and PSCCH/PSSCH transmission/reception. The WTRU may determine whether to prioritize PSFCH transmission/reception based on the number of PSFCHs the WTRU needs to transmit/receive. Specifically, if the number of PSFCHs the WTRU needs to transmit/receive is greater than a threshold, the WTRU may prioritize PSFCH transmission/reception; otherwise, if the number of PSFCHs is smaller than the threshold, the WTRU may prioritize PSCCH/PSSCH resource.

The WTRU may determine which resource to prioritize based on the channel busy ratio (CBR) of the resource pool associated with the resource. For example, the WTRU may prioritize transmitting the resource(s) in the resource pool having a lower CBR.

The WTRU may be configured or preconfigured to prioritize one RAT (e.g., LTE SL RAT, NR SL RAT, Uu RAT) over another RAT. In some examples, the WTRU may prioritize an LTE SL RAT over a NR SL RAT. The WTRU may then perform a prioritization procedure to deprioritize the resource(s) in the NR RAT, which may include dropping, rate-matching/puncturing, and reducing the transmission power of the resource(s) in the NR RAT. In some examples, the WTRU may prioritize a Uu RAT over the NR SL RAT.

In another example, the WTRU may determine which resource to prioritize based on the synchronization status of one carrier. For example, the WTRU may determine whether to prioritize SL-SSB reception in one carrier over transmission/reception in another carrier based on the synchronization status of the WTRU in the carrier. Specifically, if the carrier is synchronized, the WTRU may prioritize transmission/reception of one or more channels in other carriers. Otherwise, if the carrier is off synced, the WTRU may prioritize SL-SSB reception in the carrier.

In some embodiments as may be described herein, a WTRU may perform prioritization among transmission and reception resources. In some solutions, the WTRU may perform prioritization between transmission and receptions resources, which may be in the same or different carriers. The WTRU may then determine whether to perform transmission or reception based on one or any combination of parameters, factors, or conditions as described in the following examples.

The WTRU may determine whether to perform transmission or reception based on the number of resources/channels to transmit and/or receive. For example, the WTRU may prioritize transmission if the number of resources/channels the WTRU is expected to transmit is larger than the number of resources/channels the WTRU is expected to receive. For example, the WTRU may prioritize transmission if the number of resources/channels the WTRU is expected to transmit is greater than a threshold, which may be configured or preconfigured per carrier. For example, the WTRU may prioritize reception if the number of resources/channels the WTRU is expected to receive is greater than a threshold, which may be configured or preconfigured per carrier.

The WTRU may determine whether to perform transmission or reception based on the physical channel associated with the transmission/reception resource. For example, the WTRU may prioritize PSFCH reception over PSCCH/PSSCH transmission. For example, the WTRU may prioritize PSFCH reception over PSCCH/PSSCH transmission if two transmissions have the same priority. In a further example, the WTRU may prioritize PSCCH/PSSCH transmission over PSCCH/PSSCH reception. For example, the WTRU may prioritize PSCCH/PSSCH transmission over PSCCH/PSSCH reception if two resources have the same priority.

The WTRU may determine whether to perform transmission or reception based on the carrier associated with each resource. For example, the WTRU may be configured or preconfigured with a priority associated with each carrier. The WTRU may determine whether to perform transmission/reception in one carrier or transmission/reception in another carrier if there is overlapping between two carriers based on the associated priority of each carrier. The WTRU may prioritize transmission/reception in the carrier with higher priority.

The WTRU may determine whether to perform transmission or reception based on the scheduling mode of the PSCCH/PSSCH and the associated PSFCH. For example, the WTRU may prioritize transmission/reception of the resource(s) scheduled by the network over the resource(s) autonomously selected by itself.

The WTRU may determine whether to perform transmission or reception based on the number of occupied resources in the time domain, frequency domain or both. For example, the WTRU may prioritize transmission/reception of the resource(s) having the larger number of occupied resources in the time domain, frequency domain or both. For example, the WTRU may prioritize transmission/reception of the resource having the smaller number of occupied resources in the time domain, frequency domain or both.

In some example solutions, a WTRU may perform prioritization among PSFCH transmissions. The WTRU may be scheduled with multiple subsets of PSFCH transmission resources which may be overlapping in the time domain. Each subset of PSFCH transmission resources may include the PSFCH resources in the same carrier. The WTRU may then perform prioritization among multiple PSFCH resources or multiple subsets of PSFCH transmission resources to determine which PSFCH transmission resources and/or which subset(s) of PSFCH transmission resources to use for transmission. In some approaches, the WTRU may include all scheduled PSFCH resources for potential transmission. The WTRU may then sequentially remove one or more PSFCH transmission resources until it is able to perform transmission in all the remaining PSFCH resources. In another approach, the WTRU may sequentially add one and/or one set of PSFCH resources to perform PSFCH transmission until it is not able to send transmissions on all of the PSFCH resources.

In some example solutions, a WTRU may determine the number of PSFCH transmissions to transmit simultaneously in multiple carriers. For instance, in some solutions, the WTRU may determine the number of PSFCH transmissions (e.g., the maximum, minimum, and the exact number of PSFCH transmissions) to transmit simultaneously in multiple carriers based on the carrier aggregation setting. Specifically, the WTRU may determine to transmit (e.g., the maximum, minimum, and the exact number) N1 PSFCHs for a single carrier case. The WTRU may determine to transmit (e.g., maximum, minimum, or exactly) N2 PSFCH transmissions for two contiguous carriers cases. The WTRU may determine to transmit (e.g., maximum, minimum, or exactly) N3 (e.g., N1>N2>N3) PSFCH transmissions for two non-contiguous carriers cases.

In some solutions a WTRU may determine which carrier to transmit PSFCH transmissions on. The WTRU may have PSFCHs from multiple carriers to perform simultaneous PSFCH transmission. The WTRU may first determine which carrier to be used to transmit based on the priority of the PSFCH in each carrier. Specifically, the WTRU may select the carrier of the PSFCH transmission resource having the highest priority. If two or more carriers have the same highest priority, the WTRU may select the carrier to transmit a PSFCH transmission based on one or any combination of the following: the carrier having the highest number of PSFCHs; the carrier resulting in the highest total transmission power; or the carrier resulting in the highest transmission power per PSFCH.

In some solutions, a WTRU may determine which carrier(s) to add to the set of carriers for simultaneous PSFCH transmission. The WTRU may determine to transmit simultaneous PSFCH transmissions in multiple carriers. The WTRU may first add one carrier for potential PSFCH transmission (e.g., the carrier having the PSFCH with the highest priority). The WTRU may additionally determine which carrier(s) to add for PSFCH transmission based on one or any combination of the following parameters.

The WTRU may determine which carrier(s) to add to the set of carriers for simultaneous PSFCH transmission based on the frequency gap with reference to a previously/firstly selected carrier. Specifically, the WTRU may determine to add the carrier having the smallest frequency gap to the previously/firstly selected carrier (e.g., an adjacent carrier with the previously/firstly selected carrier). If there are multiple such carriers, the WTRU may add the carrier having the highest priority of PSFCH.

The WTRU may determine which carrier(s) to add to the set of carriers for simultaneous PSFCH transmission f based on a priority of the PSFCHs in the carrier. Specifically, the WTRU may determine to additionally include in the set of carriers for simultaneous PSFCH transmission the carrier having the highest priority of the PSFCH.

In some solutions, a WTRU may determine which carrier(s) to drop from simultaneous PSFCH transmissions. The WTRU may be scheduled with PSFCH transmission resources in multiple carriers. The WTRU may not be able to perform simultaneous PSFCH transmission in all carriers. The WTRU may determine to drop one or more carriers. The WTRU may first select one prioritized carrier for PSFCH transmission (e.g., the carrier having the highest priority PSFCH). The WTRU may then determine which carrier(s) to drop based on one or any combination of parameters as may be described in the following examples.

The WTRU may determine to drop one or more carriers based on the frequency gap to the prioritized carrier. Specifically, the WTRU may determine to drop the carrier having the largest frequency gap to the previously/firstly selected carrier. If there are multiple such carriers, the WTRU may drop the carrier having the lower priority of the highest priority PSFCH in the carrier.

The WTRU may determine to drop one or more carriers based on the priority of the PSFCHs in the carrier. Specifically, the WTRU may drop the carrier having the lower priority of the highest priority PSFCH in the carrier compared to the non-dropped carriers.

In some solutions, a WTRU may determine which PSFCH to drop from the set of PSFCH transmission resources. The WTRU may be scheduled with multiple PSFCHs for simultaneous PSFCH transmission from one or more carriers. The WTRU may not be able to perform simultaneous transmission in all PSFCH resources. The WTRU may determine to drop one or more PSFCH resources from the set of simultaneous PSFCH transmissions. The WTRU may first select a prioritized PSFCH resource (e.g., the PSFCH resource having the highest priority). The WTRU may then determine which PSFCH to drop based on one or any combination of parameters as described in the following examples.

The WTRU may determine which PSFCH to drop based on the carrier gap between the firstly/previously selected PSFCH and the carrier of the considered PSFCH. For example, the WTRU may drop the PSFCH having the largest carrier gap to the firstly/previously selected PSFCH. For example, for intraband carrier aggregation, the WTRU may first drop the PSFCH in the carrier, which is non-contiguous with the carder of the firstly/previously selected PSFCH. The WTRU may then drop the PSFCH in the carrier in the carrier contiguous with the carrier of the firstly/previously selected PSFCH if the WTRU is not able to perform simultaneous PSFCH transmission in the two contiguous carriers. The WTRU may finally drop the PSFCH in the same carrier with the firstly/previously selected PSFCH if the WTRU is not able to perform simultaneous PSFCH transmission in the carrier.

The WTRU may determine which PSFCH to drop based on the frequency gap to the firstly/previously selected PSFCH (e.g., the PSFCH having the highest priority). For example, the WTRU may drop the PSFCH having the largest frequency gap to the firstly/previously selected PSFCH.

The WTRU may determine which PSFCH to drop based on the priority of the PSFCH. For example, the WTRU may drop the PSFCH having the lowest priority.

In some embodiments, the WTRU may firstly/previously select a prioritized PSFCH. The WTRU may then drop all the PSFCHs in the carrier in which the WTRU may not be able to perform simultaneous transmission (e.g., the carrier resulting in non-contiguous simultaneous CA). If the WTRU may be able to perform simultaneous transmission in the remaining carrier, the WTRU may determine which PSFCH resource to drop based on its priority. Specifically, the WTRU may drop the PSFCH resource having the lowest priority until the WTRU is able to perform simultaneous PSFCH transmission.

In some solutions, a WTRU may determine which PSFCH to add to the set of PSFCH transmission resources. The WTRU may be scheduled with multiple PSFCHs for simultaneous PSFCH transmission from one or more carriers. The WTRU may not be able to perform simultaneous transmission in all PSFCH resources. The WTRU may first select a prioritized PSFCH resource (e.g., the PSFCH resource having the highest priority). The WTRU may then determine which PSFCH to add to the set of simultaneous PSFCH transmission resources based on one or any combination of parameters as described in the following examples.

The WTRU may then determine which PSFCH to add to the set of simultaneous PSFCH transmission resources based on the priority of the PSFCH resource. For example, the WTRU may sequentially add the resource having the highest priority from the remaining set of scheduled PSFCH resources.

The WTRU may then determine which PSFCH to add to the set of simultaneous PSFCH transmission resources based on the carrier associated with the PSFCH. For example, the WTRU may add the resource in the carrier having the smallest frequency gap to the carrier of the firstly/previously prioritized/selected PSFCH resource.

In some embodiments, the WTRU may firstly/previously select a prioritized PSFCH. The WTRU may then determine which carrier to add to the set of carriers to perform simultaneous PSFCH transmission. The WTRU may then sequentially add the PSFCHs in the set of selected carriers based on their priorities. Specifically, the WTRU may sequentially add a PSFCH resource having the highest priority from the remaining set of scheduled PSFCH resources.

In some embodiments, the WTRU may firstly/previously select a prioritized PSFCH. The WTRU may then sequentially add the PSFCH resources in the carriers of the prioritized PSFCH resources. The WTRU may then sequentially add another carrier, which may have the smallest frequency gap to the firstly/previously selected/prioritized carrier. The WTRU may then sequentially add the PSFCH in the carriers based on the priority of the PSFCH. The WTRU continues the procedure until it may not be able to add another carrier from the set of simultaneous PSFCH transmission.

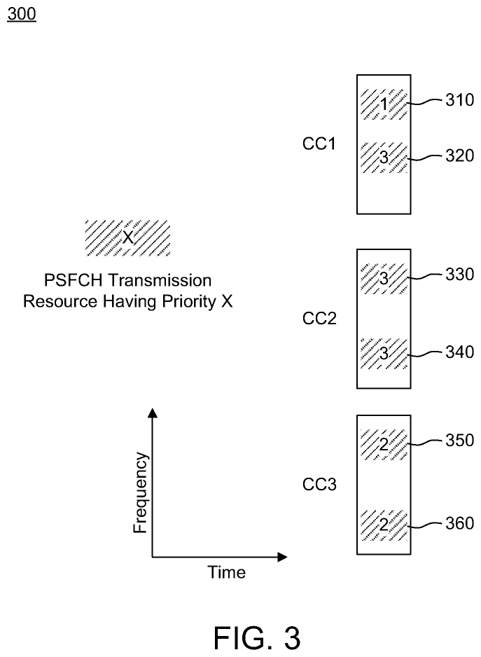

FIG. 3 is a resource diagram illustrating an example scenario of PSFCH carrier selection for simultaneous PSFCH transmission. As shown in resource diagram 300, the WTRU may be scheduled with PSFCHs in three carriers, in which each PSFCH has its associated priority. The WTRU may first determine to add the first Component Carrier (CC), such as, for example, CC1, to the set of simultaneous PSFCH transmission(s) because it has the highest priority PSFCH, in which the highest priority is equivalent to the lowest priority value. For example, CC1 has PFSCH transmission 310 which has a priority of 1, making it the highest priority PSFCH transmission in FIG. 3. In comparison PFSCH transmission 320 has a priority of 3, PFSCH transmission 330 has a priority of 3, PFSCH transmission 340 has a priority of 3, PFSCH transmission 350 has a priority of 2 and PFSCH transmission 360 has a priority of 2.

The WTRU may then determine to add another CC to the set of simultaneous PSFCH transmissions. Accordingly, the WTRU may choose between CC2 and CC3 in the example shown in FIG. 3. The WTRU may then determine to add CC2 to the set of simultaneous PSFCH transmissions because CC2's frequency gap with CC1 is smaller than CC3's frequency gap with CC1. As seen in the example shown in FIG. 3, CC2 is adjacent to CC1. In this way, the WTRU chooses CC2 over CC3 even though the PFSCH transmissions of CC3 have a higher priority than the PFSCH transmissions of CC2. The WTRU may then determine to perform simultaneous PSFCH transmission for the PSFCH transmissions in CC1 and CC2.

In some solutions, a WTRU may perform prioritization between PSCCH/PSSCH and PSFCH resources. For instance, in some solutions, the WTRU may perform prioritization between PSCCH/PSSCH and PSFCH resources, in which the PSCCH/PSSCH and PSFCH resources may be in the same carrier or different carriers. Specifically, the WTRU may determine to perform one or any combination of procedures to prioritize between PSCCH/PSSCH transmission resource and PSFCH transmission and/or reception resource, as described in the following examples.

The WTRU may perform puncturing/rate-matching of the overlapping symbols between PSFCH resources and the PSCCH/PSSCH resource. The WTRU may drop a PSCCH/PSSCH or PSFCH resource. The WTRU may reduce the transmission power of the non-prioritized resource.

In some solutions, a WTRU may determine whether to drop one or more non-prioritized resource(s) or puncture/rate-match a PSCCH/PSSCH. For instance, in some solutions, the WTRU may determine whether to drop the non-prioritized resource(s) or puncture/rate match the overlapping regions between the PSFCH resources and the PSCCH/PSSCH of the PSCCH/PSSCH resource(s) based on one or any combination of the following example aspects. In examples, the non-prioritized resource(s) may be PSCCH/PSSCH resource(s), PSFCH resource(s) or the like.

A WTRU may determine whether to drop the non-prioritized resource(s) or puncture/rate-match PSCCH/PSSCH based on a configuration or pre-configuration from the resource pool/carrier. For example, the WTRU may be configured or preconfigured in the resource pool regarding whether to drop or puncture/rate-match PSCCH/PSSCH if there is overlapping between PSCCH/PSSCH and another resource in another carrier. The WTRU may then determine to drop or puncture PSCCH/PSSCH according to the configuration in the resource pool. For example, the WTRU may be configured or preconfigured whether to drop the PSFCH or rate-match/puncture PSCCH/PSSCH in the resource pool when PSFCH is deprioritized. The WTRU may follow the configuration from the resource pool or the preconfiguration from the resource pool.

A WTRU may determine whether to drop the non-prioritized resource(s) or puncture/rate-match PSCCH/PSSCH based on the location of the overlapping region. For example, the WTRU may determine to puncture/rate-match the overlapping symbols of PSCCH/PSSCH between PSCCH/PSSCH and PSFCH if the PSFCH and PSCCH/PSSCH are overlapped in the last symbol(s) of the PSCCH/PSSCH resource(s). For example, the WTRU may determine to drop the non-prioritized resource(s) if the PSFCH resource occurs in the middle of the PSCCH/PSSCH resources. In examples, the non-prioritized resource(s) may be PSCCH/PSSCH resource(s), PSFCH resource(s) or the like.

A WTRU may determine whether to drop the non-prioritized resource(s) or puncture/rate-match PSCCH/PSSCH based on content of the potential dropping symbol(s). For example, the WTRU may make its determination based on whether the dropping symbol(s) contain one or more of a demodulation reference signal (DMRS), a PSCCH, 2nd SCI, and the like. For example, the WTRU may drop one resource if the potential dropping symbols contain PSCCH, 2nd SCI, and/or DMRS. Otherwise, the WTRU may perform puncturing/rate matching of the PSCCH/PSSCH resource. In examples, the dropped one resource may be a PSFCH resource or a PSCCH/PSSCH resource.

A WTRU may determine whether to drop the non-prioritized resource(s) or puncture/rate-match PSCCH/PSSCH based on the amount of the overlapping region between two resources. For example, the WTRU may determine whether to drop one resource or puncture/rate-match the PSCCH/PSSCH resource based on the overlapping duration between two resources. Specifically, if the overlapping duration between two resources is greater than a threshold, the WTRU may determine to drop one resource. Additionally or alternatively, if the overlapping duration between two resources is smaller than a threshold, the WTRU may determine to puncture/rate-match the PSCCH/PSSCH resource. The threshold may be fixed, configured in the resource pool, or preconfigured in the resource pool, which may be further determined based on WTRU capability.

A WTRU may determine whether to drop the non-prioritized resource(s) or puncture/rate-match PSCCH/PSSCH based on the number of potential rate-matched/punctured symbols. For example, the WTRU may perform PSCCH/PSSCH rate-matching/puncturing if the number of potential rate-matched/punctured symbols is smaller than a threshold; otherwise, the WTRU may drop one deprioritized resource. The threshold may be fixed, configured in the resource pool or preconfigured in the resource pool.

A WTRU may determine whether to drop the non-prioritized resource(s) or puncture/rate-match PSCCH/PSSCH based on the synchronization status between two resources. For example, the WTRU may determine whether to drop one resource or puncture/rate-match the PSCCH/PSSCH resource based on the synchronization status between two resources/carriers. Specifically, the WTRU may drop one resource if the two carriers are not synchronized. Otherwise, if two carriers are synchronized, the WTRU may perform either resource dropping or resource puncturing/rate-matching.

A WTRU may determine whether to drop or puncture/rate-match PSCCH/PSSCH based on the QoS of the PSCCH/PSSCH resource. In an example, the QoS may be a priority. For example, the WTRU may determine to drop the PSCCH/PSSCH resource if the QoS (e.g., priority) of the PSCCH/PSSCH resource is smaller than a threshold; otherwise, if the priority of the PSCCH/PSSCH resource is larger than a threshold, the WTRU may perform puncturing/rate-matching of the PSCCH/PSSCH resource. The threshold may be configured in the resource pool or preconfigured in the resource pool. This approach may be motivated to help the WTRU to reduce the resource dropping of high-priority transport blocks (TBs).

A WTRU may determine whether to drop the non-prioritized resource(s) or puncture/rate-match PSCCH/PSSCH based on a priority of the PSFCH. For example, the WTRU may determine whether to drop PSFCH or rate-match/puncture PSCCH/PSSCH based on the priority of the PSFCH. Specifically, the WTRU may drop PSFCH if the priority of the PSFCH is smaller than a threshold. Otherwise, if the priority of the PSFCH is larger than the threshold, the WTRU may rate-match/puncture the overlapping symbols between PSFCH and PSCCH/PSSCH resources.

A WTRU may determine whether to drop the non-prioritized resource(s) or puncture/rate-match PSCCH/PSSCH based on the number of PSFCHs to be transmitted/received. For example, the WTRU may determine whether to drop one resource, for example, PSFCHs, or rate-match/puncture PSCCH/PSSCH based on the number of PSFCHs to be transmitted/received. Specifically, the WTRU may drop one resource, for example, PSFCHs if the number of PSFCHs to be transmitted/received is smaller than a threshold. Otherwise, the WTRU may rate-match/puncture PSCCH/PSSCH in the overlapping symbols between two resources.

A WTRU may determine whether to drop the non-prioritized resource(s) or puncture/rate-match PSCCH/PSSCH based on the amount of the overlapping region between two resources. For example, the WTRU may determine whether to drop one non-prioritized resource or rate-match/puncture PSCCH/PSSCH based on the number of overlapping symbols between two resources and/or the number of potential rate-matched/punctured symbols. Specifically, the WTRU may determine to puncture/rate-match PSCCH/PSSCH resource if the number of rate-matched/punctured slots is smaller than a threshold; otherwise, the WTRU may drop one non-prioritized resource.

A WTRU may determine whether to drop the non-prioritized resource(s) or puncture/rate-match PSCCH/PSSCH based on the information conveyed in the transmission. For example, the WTRU may determine whether to drop or puncture/rate-match PSCCH/PSSCH based on the information conveyed in PSCCH/PSSCH and/or PSFCH. For example, the WTRU may determine whether to drop PSFCH or rate-match/puncture PSCCH/PSSCH based on the information conveyed in PSFCH. For example, the WTRU may drop PSFCH if it conveys IUC information. Otherwise, if the PSFCH the PSFCH conveys ACK/NACK feedback, the WTRU may puncture/rate-match the PSCCH/PSSCH resource.

A WTRU may determine whether to drop the non-prioritized resource(s) or puncture/rate-match PSCCH/PSSCH based on a HARQ feedback type. For example, the WTRU may determine whether to drop one non-prioritized resource or rate-match/puncture PSCCH/PSSCH based on the number of overlapping symbols between two resources and/or the number of potential rate-matched/punctured slots. Specifically, the WTRU may determine to puncture/rate-match PSCCH/PSSCH resource if the number of rate-matched/punctured slots is smaller than a threshold; otherwise, the WTRU may drop one non-prioritized resource.

A WTRU may determine whether to drop the non-prioritized resource(s) or puncture/rate-match PSCCH/PSSCH based on the RATs associated with the resource(s). For example, the WTRU may determine whether to drop the non-prioritized resource or rate-match/puncture the PSCCH/PSSCH resource based on the RATs associated with the resources. For example, the WTRU may drop the PSCCH/PSSCH resource if the resource is in LTE SL RAT. Additionally or alternatively, the WTRU may drop or rate-match/puncture PSCCH/PSSCH resource if the resource is in NR SL RAT.

A WTRU may determine whether to drop the non-prioritized resource(s) or puncture/rate-match PSCCH/PSSCH based on the scheduling mode of the PSCCH/PSSCH and the associated PSCCH/PSSCH of the PSFCH transmission. For example, the WTRU may determine whether to drop a non-prioritized resource or rate-match/puncture PSCCH/PSSCH based on the scheduling mode of PSCCH/PSSCH associated with the PSFCH. Specifically, if PSFCH is deprioritized, the WTRU may rate-match/puncture PSCCH/PSSCH if the PSCCH/PSSCH of the associated PSFCH is scheduled by the base station. Otherwise, if the PSCCH/PSSCH of the associated PSFCH is autonomously selected by the WTRU, the WTRU may drop the PSFCH. This approach may be motivated to prioritize the resource scheduled by the network over the resource selected by the WTRU. In an example, the base station may be a gNB.

A WTRU may determine whether to drop the non-prioritized resource(s) or puncture/rate-match PSCCH/PSSCH based on the transmission/reception duration of the resource. For example, the WTRU may determine whether to drop one resource or rate-match/puncture PSCCH/PSSCH based on the transmission/reception duration of PSCCH/PSSCH. Specifically, the WTRU may puncture/rate-match the PSCCH/PSSCH if the transmission duration of PSCCH/PSSCH is larger than a threshold; otherwise, the WTRU may drop one non-prioritized one.

A WTRU may determine whether to drop the non-prioritized resource(s) or puncture/rate-match PSCCH/PSSCH based on a subcarrier spacing associated with the resource. For example, the WTRU may determine whether to drop one resource or rate-match/puncture PSCCH/PSSCH based on the subcarrier spacing of PSCCH/PSSCH and/or PSFCH. For example, the WTRU may puncture/rate-match the PSCCH/PSSCH if the SCS of PSCCH/PSSCH is smaller than a threshold; otherwise, the WTRU may drop one non-prioritized one. For example, the WTRU may puncture/rate-match the PSCCH/PSSCH if the SCS of the PSFCH resource is smaller than a threshold. Otherwise, the WTRU may drop one non-prioritized resource. The threshold may be configured or preconfigured in the carrier, which may be a function of the SCSs of the two carriers having resources subject to prioritizing.

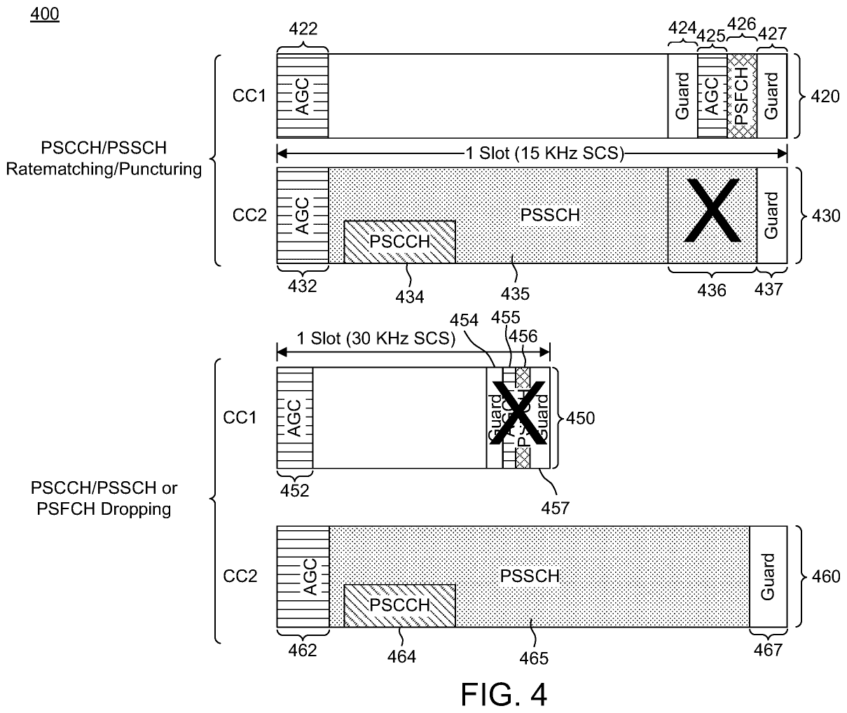

FIG. 4 is a resource diagram illustrating an example procedure performed by a WTRU for prioritization between PSFCH resources and PSCCH/PSSCH resources. In an example shown in resource diagram 400, the WTRU may perform prioritization between PSCCH/PSSCH resources and PSFCH resources in two different carriers. For example, the WTRU may transmit a PSFCH transmission in CC1 and a PSCCH transmission, a PSSCH transmission or both in CC2.

In an example case shown in resource diagram 400, the WTRU may transmit a PFSCH transmission using PSFCH resources 426, and other resources may be used for other purposes in a component carrier 420, which may be referred to as CC1. For example, resources 422 and resources 425 may be used by the WTRU to carry out AGC. Further, resources 424 and resources 427 may be used by the WTRU for guard periods or guard symbols. In an example, one slot on CC1 may have an SCS of 15 KHz.

The PSFCH resources 426 may be associated with a PSCCH/PSSCH transmission made earlier on CC1 420. In examples, the information conveyed in the PSFCH transmission may be IUC information, an ACK indication, an NACK indication and the like. For example, the WTRU may transmit a PSCCH/PSSCH transmission using CC1 420 and later receive HARQ information regarding the PSCCH/PSSCH transmission, such as an ACK indication, in a PSFCH transmission received using PSFCH resources 426. In another example, the WTRU may successfully receive a PSCCH/PSSCH transmission using CC1 420 and later transmit HARQ information regarding the PSCCH/PSSCH transmission, such as an ACK indication, in a PSFCH transmission transmitted using PSFCH resources 426.

Further, the WTRU may transmit a PSCCH transmission using PSCCH resources 434 and may transmit a PSSCH transmission using PSSCH resources 435 using a component carrier 430, which may be referred as CC2. In an example, the WTRU may transmit a PSCCH/PSSCH transmission using PSCCH/PSSCH resources 434, 435. Further, resources 432 may be used by the WTRU to carry out AGC and resources 437 may be used by the WTRU for guard periods or guard symbols. In an example, PSFCH resources 426 may occur at the same time as the last symbols or last resources 436 of the PSSCH resources 435 (which may also be used for PSCCH resources). The WTRU may perform transmission, reception or both in both resources 436 and resources 426. Accordingly, the WTRU may rate-match, may puncture or may do both to the overlapping symbols or overlapping resources between resources 436 and resources 426. For example, the WTRU may rate-match/puncture the part of the PSCCH/PSSCH transmission transmitted using resources 436. Accordingly, the WTRU may rate-match/puncture around the symbols used in the resources for a guard period 424, 427, the resources for an AGC 425 and the PSFCH resources 426. In this way, collision with the transmission/reception of a PSFCH transmission using PSFCH resources 426, and related resources 424, 425, 427, may be avoided.

Further, the WTRU may implicitly inform, may explicitly inform or both the reception WTRU of the puncturing/rate-matching event to help the reception WTRU decode the transmission correctly. In an example, the WTRU may use SCI to implicitly inform, explicitly inform or both the reception WTRU. For example, the WTRU may use SCI to inform the reception WTRU of puncturing/rate-matching of the PSSCH transmission transmitted using resources 436. In an example, resources 436 may be considered to be a sub-set of resources 435.

In another example case shown in resource diagram 400, the WTRU may transmit a PFSCH transmission using PSFCH resources 456 and other resources may be used for other purposes in a component carrier 450, which may be referred to as CC1. For example, resources 452 and resources 455 may be used by the WTRU to carry out AGC. Further, resources 454 and resources 457 may be used by the WTRU for guard periods or guard symbols. In an example, one slot using CC1 450 may have an SCS of 30 KHz.

The PSFCH resources 456 may be associated with a PSCCH/PSSCH transmission made earlier using CC1 450. In examples, the information conveyed in the PSFCH transmission may be IUC information, an ACK indication, an NACK indication and the like. For example, the WTRU may transmit a PSCCH/PSSCH transmission using CC1 450 and later receive HARQ information regarding the PSCCH/PSSCH transmission, such as an ACK indication, in a PSFCH transmission received using PSFCH resources 456. In another example, the WTRU may successfully receive a PSCCH/PSSCH transmission using CC1 450 and later transmit HARQ information regarding the PSCCH/PSSCH transmission, such as an ACK indication, in a PSFCH transmission transmitted using PSFCH resources 456

Moreover, on a component carrier 460, which may be referred as CC2, the WTRU may transmit a PSCCH transmission using PSCCH resources 464 and may transmit a PSSCH transmission using PSSCH resources 465. In an example, the WTRU may transmit a PSCCH/PSSCH transmission using PSCCH/PSSCH resources 464, 465. Further, resources 462 may be used by the WTRU to carry out AGC and resources 467 may be used by the WTRU for guard periods or guard symbols. In an example, PSFCH resources 456 may occur at the same time as the middle of resources of the PSSCH resources 465 (which may also be used for PSCCH resources). The WTRU may perform transmission, reception or both in both resources 465. Accordingly, the WTRU may determine to drop one or more non-prioritized resource(s) for the PSFCH transmission in the overlapping symbols or overlapping resources between resources 456 and resources 465. Specifically, in an example case shown in resource diagram 400, the WTRU may drop PSFCH resource 456. Accordingly, the WTRU may also not use guard resources 454, 457 and AGC resources 455. The WTRU may drop PSFCH resources 456 due to the lower priority of the PSFCH resources 456 as compared to resources 465. In an example, the overlapping symbols or overlapping resources may occur in the middle of the resources 465 used for PSCCH/PSSCH transmission, which is different than the end resources 436 of resources 435 due to the different SCSs of the two carriers in the two example cases. For example, CC1 420 may have an SCS of 15 KHz and CC1 450 may have an SCS of 30 KHz.

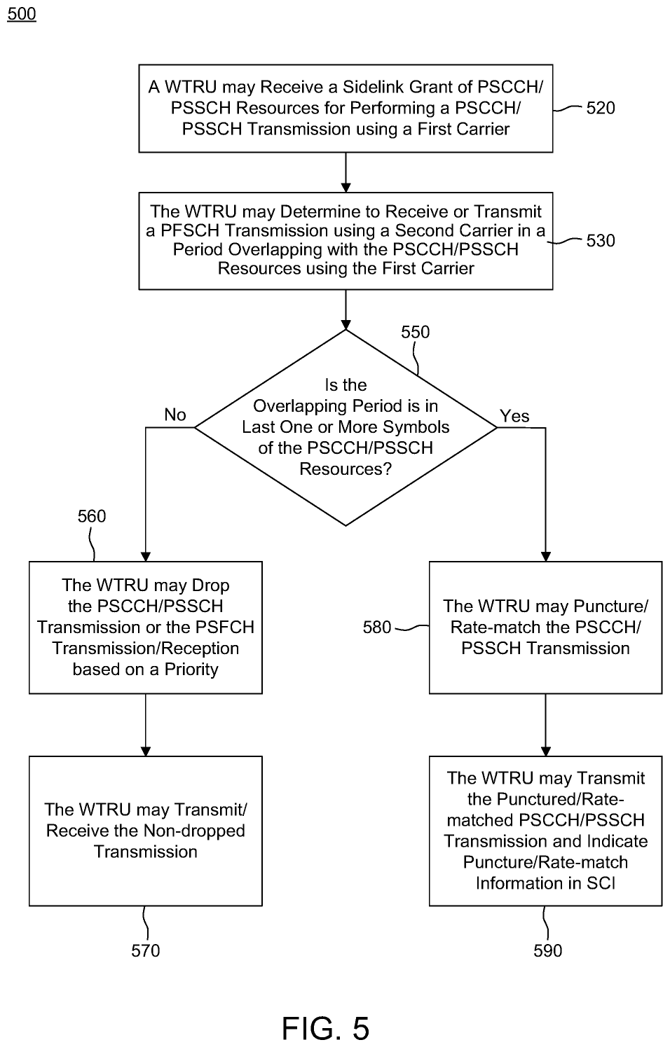

FIG. 5 is a flowchart diagram illustrating an example of prioritization between PSFCH resources and PSCCH/PSSCH resources. As shown in flowchart diagram 500, a WTRU receive a sidelink grant of resources for performing a PSCCH/PSSCH transmission using a first carrier 520. In an example, the resources may be PSCCH/PSSCH resources. In a further example, the resource may be selected by the WTRU for use without a recent grant.

Further, the WTRU may determine that it expects to receive or transmit a PSFCH transmission using a second carrier in a period overlapping with the PSCCH/PSSCH resources using the first carrier 530. Accordingly, the WTRU may determine that a collision will result in an overlapping period without a change in at least one expected transmission or reception.

Moreover, the WTRU may determine whether the overlapping period is in last one or more symbols of the PSCCH/PSSCH resources 550. If, or on a condition that, the overlapping period is not in the last one or more symbols of the PSCCH/PSSCH resources, the WTRU may drop the PSCCH/PSSCH transmission or the PSFCH transmission/reception 560. In this way, collision is avoided. For example, if the overlapping period is in a middle period the PSCCH/PSSCH resources, the WTRU may drop the PSCCH/PSSCH transmission or the PSFCH transmission/reception. The WTRU may drop the less prioritized transmission. Further, the WTRU may transmit/receive the non-dropped transmission 570. For example, if the PSCCH/PSSCH transmission is more prioritized than the PSFCH transmission/reception, the WTRU may drop the PSFCH transmission and transmit the PSCCH/PSSCH transmission.

Similarly, if the PSFCH transmission/reception is more prioritized than the PSCCH/PSSCH transmission, the WTRU may drop the PSCCH/PSSCH transmission and may perform PSFCH transmission or PSFCH reception. Accordingly, the WTRU may transmit the PSFCH transmission or receive the PSFCH transmission while dropping the PSCCH/PSSCH transmission.

If, or on a condition that, the overlapping period is in last symbols of the PSCCH/PSSCH resources, the WTRU may puncture or rate-match the PSCCH/PSSCH transmission 580. In this way, collision is avoided. As a result, the WTRU may transmit the punctured/rate-matched PSCCH/PSSCH transmission 590. Accordingly, the WTRU may transmit the PSCCH/PSSCH transmission in a first set of symbols in the overlapping period and not transmit the PSCCH/PSSCH transmission in a second set of symbols in the overlapping period. Further, the WTRU may indicate the puncture/rate-match information in SCI. The WTRU, acting as a transmission WTRU, may transmit this SCI to a sidelink reception WTRU. In examples, the transmission WTRU may indicate the puncture/rate-match information explicitly. In other examples, the transmission WTRU may indicate the puncture/rate-match information implicitly.

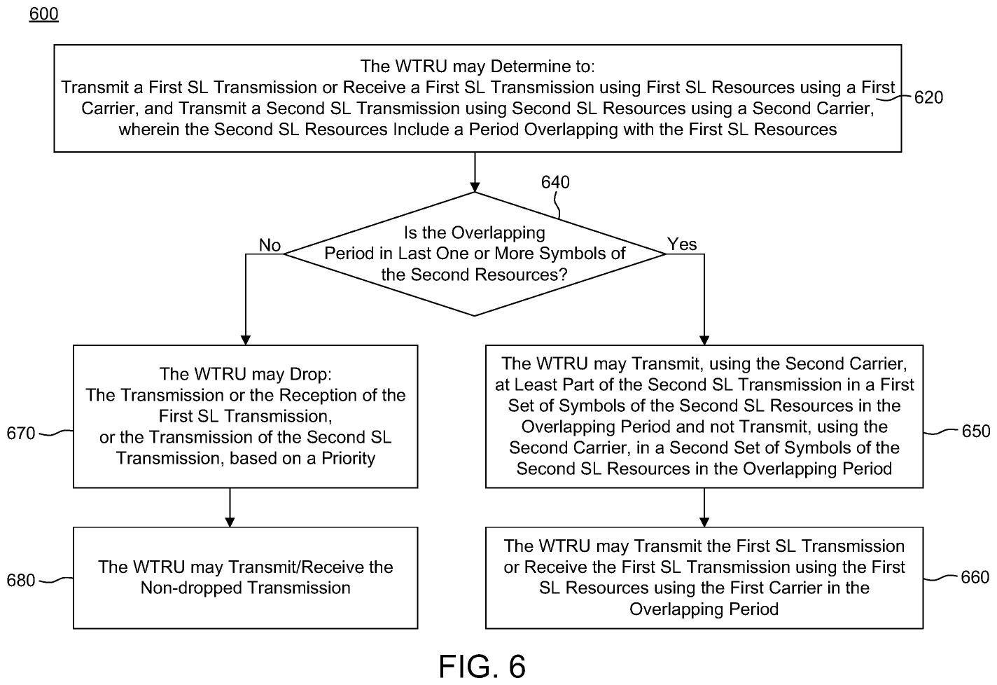

FIG. 6 is a flowchart diagram illustrating an example of prioritization between a first SL transmission and a second SL transmission. In an example shown in flowchart diagram 600, a WTRU may determine to transmit or receive a first sidelink (SL) transmission using first SL resources using a first carrier, and to transmit a second SL transmission using second SL resources using a second carrier 620. In an example, the second SL resources may include an overlapping period. Further, the second SL resources may overlap with the first SL resources in the overlapping period. Specifically, the WTRU may determine if the overlapping period is in the last one or more symbols of the second SL resources 640. If the overlapping period is in the last one or more symbols of the second SL resources, the WTRU may transmit, using the second carrier, at least part of the second SL transmission in a first set of symbols of the second SL resources in the overlapping period and not transmit, using the second carrier, in a second set of symbols of the second SL resources in the overlapping period 650. Further, the WTRU may transmit or receive the first SL transmission using the first SL resources using the first carrier in the overlapping period 660.

In an example, the first SL resources may include first time resources, and the second SL resources may include second time resources. Also, the overlapping period may be in one or more symbols of the second time resources which overlap in time with one or more symbols of the first time resources.

In an example, the first SL transmission may be a PSFCH transmission. Also, the first SL resources may be PSFCH resources. In a further example, the second SL transmission may be a PSCCH/PSSCH transmission. Moreover, the second SL resources may be PSCCH/PSSCH resources. Further, the second SL transmission may be a PSCCH transmission. Also, the second SL transmission may be a PSSCH transmission. Moreover, the second SL transmission may be a combination of a PSCCH transmission and a PSSCH transmission. In addition, the second SL resources may be PSCCH resources. Also, the second SL resources may be PSSCH resources. Moreover, the second SL resources may be a combination of PSCCH resources and PSSCH resources.

In another example, the first SL transmission may be a PSCCH/PSSCH transmission and the first SL resources may be PSCCH/PSSCH resources. Further, the first SL transmission may be a PSCCH transmission. Also, the first SL transmission may be a PSSCH transmission. Moreover, the first SL transmission may be a combination of a PSCCH transmission and a PSSCH transmission. In addition, the first SL resources may be PSCCH resources. Also, the first SL resources may be PSSCH resources. Moreover, the first SL resources may be a combination of PSCCH resources and PSSCH resources. Further, the second SL transmission may be a PSFCH transmission. Moreover, the second SL resources may be PSFCH resources.

In another example, the transmitting, using the second carrier, at least part of the second SL transmission in a first set of symbols of the second SL resources in the overlapping period and not transmitting, using the second carrier, in a second set of symbols of the second SL resources in the overlapping period may be considered to be puncturing. Additionally or alternatively, the transmitting, using the second carrier, at least part of the second SL transmission in a first set of symbols of the second SL resources in the overlapping period and not transmitting, using the second carrier, in a second set of symbols of the second SL resources in the overlapping period may be considered to be rate matching.

Additionally or alternatively, if the overlapping period is earlier than the last one or more symbols of the second SL resources, the WTRU may drop the transmission or the reception of the first SL transmission, or drop the transmission of the second SL transmission, based on a comparison of a priority associated with the first SL resources with a priority associated with the second SL resources 670. The WTRU may then transmit or receive the non-dropped transmission 680. For example, if the overlapping period is earlier than the last one or more symbols of the second SL resources, the WTRU may compare the priority of the first SL resources with the priority of the second SL resources.

If the first SL resources have a higher priority than the second SL resources, the WTRU may then transmit or receive the first SL transmission using the first SL resources. Further, the WTRU may drop the second SL transmission.

If the second SL resources have a higher priority than the first SL resources, the WTRU may then transmit or receive the second SL transmission using the second SL resources, in an example. Also, the WTRU may drop the first SL transmission.

In a further example, the WTRU may transmit, to a reception WTRU, information regarding the first set of symbols of the second SL resources and the second set of symbols of the second SL resources in SCI. Further, the WTRU may receive an SL grant of resources for transmitting the second SL transmission using the second carrier. Additionally or alternatively, the WTRU may select resources for transmitting the second SL transmission using the second carrier.

Methods for resource allocation for multiple carriers are described herein. In some example solutions, a WTRU may perform resource exclusion to reduce resource collision. For instance, in some example solutions, the WTRU may trigger one or any combination of the following events: resource allocation; resource re-evaluation; or pre-emption.

Upon triggering one of these events, the WTRU may determine two sets of resources in the resource selection window (RSW), in which the first set of resources may be denoted as the set of collided/unavailable resources and the second set of resources may be referred to as the set of available resources. The WTRU may then perform resource selection in the second set of resources (i.e., the set of available resources). The WTRU may add one resource to the first set of resources (i.e., the set of unavailable resources) and/or exclude the resource from the second set of resources (i.e., the set of available resources), and perform resource selection in the second set of resources if the WTRU is not able to perform simultaneous transmission in the resource and transmission/reception of another resource in another carrier due to one or any combination of parameters or conditions, such as in the following.

Such a condition may be when the number of TX chains is smaller than the number of transmission/reception carriers. A condition may be when the WTRU does not support the band combination in the scheduled resources. A condition may be when the WTRU TX chain switching time of the WTRU is not satisfied to transmit in multiple carriers. A condition may be when the WTRU operates in a half-duplex band, which may not allow the WTRU to perform simultaneous transmission and reception. A condition may be when the Tx/Rx switching time of the WTRU is not satisfied to transmit in one carrier and receive in another carrier.

Specifically, the WTRU may include one resource from the first set of resources (i.e., the set of unavailable resources) and/or exclude the resource from the second set of resources (i.e., the set of available resources), and perform resource selection in the second set of resources based on one or any combination of parameters as described in the examples in the following paragraphs.

The resource selection may be based on the resources (e.g., PSCCH/PSSCH resource) in the resource selection carrier overlapping with a scheduled PSFCH transmission/reception resources of the WTRU potentially in another carrier.

For example, the WTRU may select/reserve PSCCH/PSSCH resources, for example, a semi-persistent scheduling (SPS) resource, in one carrier, for example, CC2. The WTRU may target to transmit a HARQ enabled TB in the selected/reserved PSCCH/PSSCH resources. Upon performing resource allocation in another carrier (e.g., CC1), the WTRU may add the resource (e.g., PSCCH/PSSCH resource) overlapping with the associated PSFCH resource of the selected/reserved PSCCH/PSSCH resource in another carrier (e.g., CC2) to the first set of resource (i.e., the set of unavailable resources) and/or exclude the resource (e.g., PSCCH/PSSCH resource) overlapping with the associated PSFCH resource of the selected/reserved PSCCH/PSSCH resource in another carrier (e.g., CC2) from the second set of resources (i.e., the set of available resources). The WTRU may then perform resource allocation in the second set of resources (i.e., the set of available resources).

For example, the WTRU may receive SCI from another WTRU reserving PSCCH/PSSCH resource (e.g., SPS resource), which may be used to transmit HARQ enabled TB. The WTRU may be the target receiver of the TB transmitting in the PSCCH/PSSCH resource. Upon performing resource allocation in one carrier, the WTRU may exclude the PSCCH/PSSCH resource overlapping with the associated PSFCH resource of the reserved PSCCH/PSSCH resource.

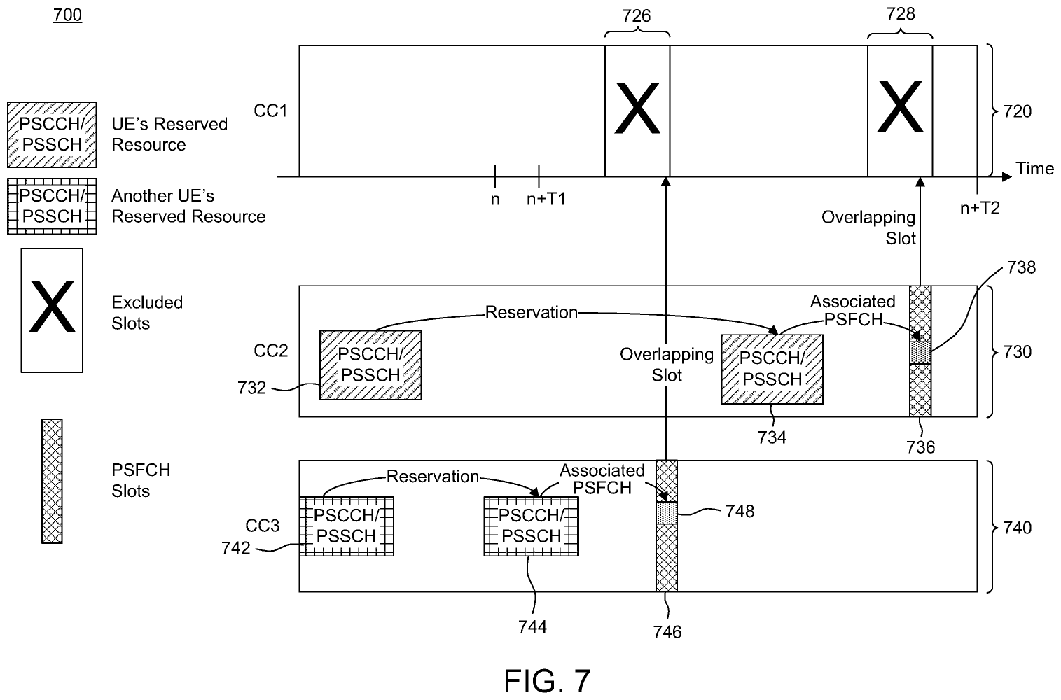

FIG. 7 is a resource diagram illustrating an example of a WTRU excluding the PSCCH/PSSCH resources overlapping with a scheduled PSFCH transmission/reception. In an example shown in resource diagram 700, the WTRU may trigger resource selection for transmission in CC1 720 at time slot n for the resource selection in the window [n+T1, n+T2]. Specifically, n may be a resource selection or resource reselection triggering slot. Also, n+T1 may be the first slot of the resource selection window. Further, n+T2 may be the last slot of the resource selection window.

The WTRU may have reserved PSCCH/PSSCH resources 734 for one PSCCH/PSSCH transmission in CC2 730 for a HARQ enabled TB. In an example, PSCCH/PSSCH resources 734 for a transmission may have been reserved by a PSCCH/PSSCH transmission using PSCCH/PSSCH resources 732. The WTRU may expect to receive PSFCH transmission 738 in the PSFCH slot 736. In an example, PSFCH transmission 738 may be associated with the PSCCH/PSSCH transmission using PSCCH/PSSCH resources 734. The WTRU may add to the first set of resources (e.g., the set of unavailable resources) and/or exclude from the second set of resources (e.g., the set of available resources) the set of slots 728 overlapping with the PSFCH slot 736 (e.g., in CC2 730) in the resource selection window (RSW) of CC1 720. For example, by performing sensing in CC3 740, the WTRU may decode SCI from another WTRU reserving PSCCH/PSSCH resources 744 semi-persistently. In an example, the SCI may be received in PSCCH/PSSCH resources 742. The WTRU may be expected to transmit PSFCH 748 in PSFCH slot 746 using CC3 740. The WTRU may add to the first set of resources (e.g., the set of unavailable resources) and/or exclude from the second set of resources (e.g., the set of available resources) the set of slots 726 overlapping with the PSFCH slot 746 (e.g., of the CC3 740) in the RSW in CC1 720.

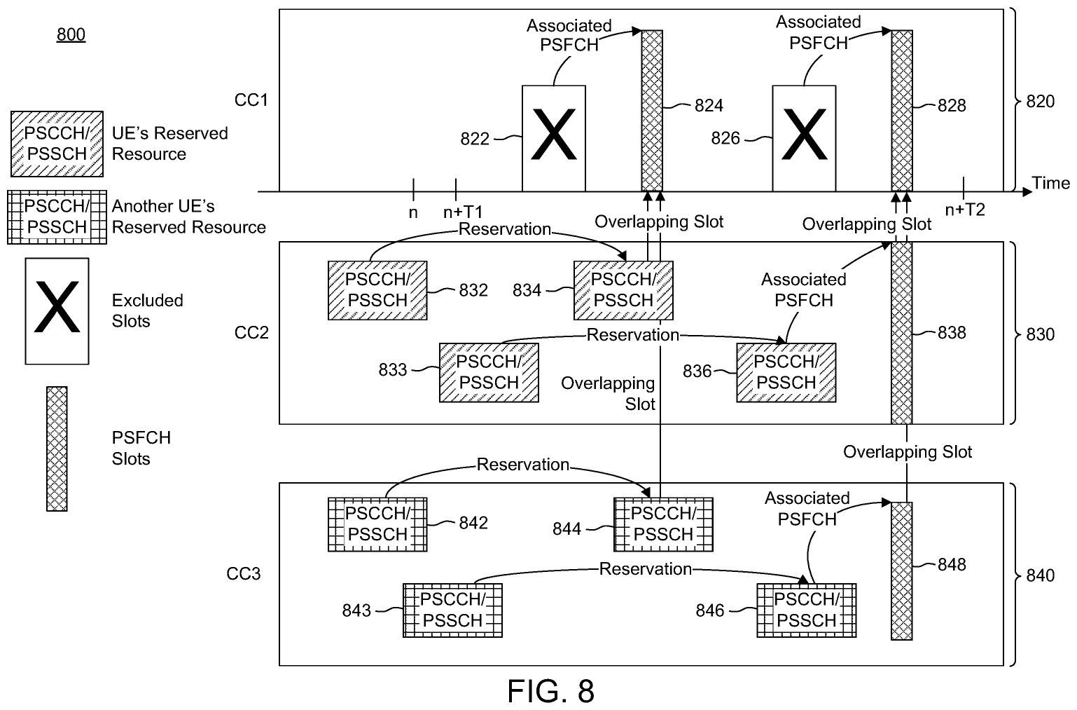

FIG. 8 is a resource diagram illustrating an example of a WTRU excluding the PSCCH/PSSCH resources having an associated PSFCH transmission/reception overlapping with the scheduled/reserved resource from another carrier. The resource selection may be based on the resource (e.g., PSCCH/PSSCH resource) in the resource allocation carrier having the associated PSFCH transmission/reception overlapping with a scheduled/reserved resource (PSCCH/PSSCH or PSFCH) in another carrier.

For example, the WTRU may be expected to transmit/receive a PSCCH/PSSCH transmission/reception or PSFCH transmission/reception in one resource. Upon performing resource allocation in another carrier (e.g., potentially for a HARQ enabled TB), the WTRU may add to the first set of resources (e.g., the set of unavailable resources) and/or exclude from the second set of resources (e.g., the set of available resources) the PSCCH/PSSCH resource having the associated PSFCH resource overlapping with the reserved/scheduled PSCCH/PSSCH or PSFCH transmission/reception resource.

In one example shown in resource diagram 800, the WTRU may trigger resource selection for transmission in CC1 820 at time slot n for the resource selection in the window [n+T1, n+T2]. As noted above, n may be a resource selection or resource reselection triggering slot. Also, n+T1 may be the first slot of the resource selection window. Further, n+T2 may be the last slot of the resource selection window.

The WTRU may add to the first set of resources (e.g., the set of unavailable resources) and/or exclude from the second set of resources (e.g., the set of available resources) the slots having associated PSFCH resources 824 overlapping with the reserved PSCCH/PSSCH resources or PSFCH resources from another carrier. For example, the WTRU may have PSCCH/PSSCH resources 834 reserved in one carrier, for example, CC2 830. In an example, PSCCH/PSSCH resources 834 may have been reserved by PSCCH/PSCCH transmission 832 and PSCCH/PSSCH resources 836 may have been reserved by PSCCH/PSCCH transmission 833. Moreover, PSFCH resources 828 may be associated with PSCCH/PSSCH resources 836. In a further example, PSCCH/PSSCH resources 844 may have been reserved by PSCCH/PSCCH transmission 842 and PSCCH/PSSCH resources 846 may have been reserved by PSCCH/PSCCH transmission 843 in carrier CC3 840. Also, PSFCH resources 848 may be associated with PSCCH/PSSCH resources 846. PSCCH/PSSCH resources 834 and PSCCH/PSSCH resources 844 may overlap with PSFCH resources 824, in an example. Further, PSFCH resources 828 may overlap with PSFCH resources 838 and PSFCH resources 848. The WTRU may add to the first set of resources (e.g., the set of unavailable resources) and/or exclude from the second set of resources (e.g., the set of available resources) the resources 822, 826 if its associated PSFCH resources 824, 828 are overlapping with reserved/scheduled PSCCH/PSSCH resources 834 or PSFCH resources 838 from the WTRU itself (e.g., the resources in CC2 830), or are overlapping with reserved/scheduled PSCCH/PSSCH resources 844 or PSFCH resources 848 from another WTRU (e.g., the resources in CC3 840), in which the WTRU may be the target receiver.

For example, the WTRU may exclude PSCCH/PSSCH resources 822 because they have associated PSFCH resources 824 which overlap with PSCCH/PSSCH resources 834 from the WTRU itself. Similarly, the WTRU may exclude PSCCH/PSSCH resources 826 because they have associated PSFCH resources 828 which overlap with PSFCH resources 838.

In a further example, the WTRU may exclude PSCCH/PSSCH resources 822 because they have associated PSFCH resources 824 which overlap with PSCCH/PSSCH resources 844 from another WTRU. Likewise, the WTRU may exclude PSCCH/PSSCH resources 826 because they have associated PSFCH resources 828 which overlap with PSFCH resources 848.

The resource selection may be based on the resource (e.g., PSCCH/PSSCH resource) in the resource allocation carrier overlapping with a configured or preconfigured SL-SSB resources from another carrier.

The resource selection may be based on the resource (e.g., PSCCH/PSSCH resource) in the resource allocation carrier overlapping with a reserved resource (e.g., PSCCH/PSSCH resource or PSFCH resource) from another carrier in which the WTRU is the target receiver.

In some solutions provided herein, a WTRU may determine whether to include a resource from a set of unavailable resources.

For instance, the WTRU may determine, for a resource allocation procedure, whether to add to the first set of resources, such as, for example, the set of unavailable resources, and/or exclude from the second set of resources, such as, for example, the set of available resources, the resources, such as, for example, PSCCH/PSSCH resources, in the resource allocation window due to the overlapping transmission/reception in another carrier based on one or any combination of the following.

The determination whether to include a resource from a set of unavailable resources, and/or exclude a resource from a set of available resources, may be based on the QoS, such as, for example, the priority, associated with the data, such as, for example, logical channel (LCH) data, triggering resource allocation. In some approaches, the WTRU may add the resources (e.g., PSCCH/PSSCH) to the first set of resources (e.g., the set of unavailable resources) and/or exclude the resource from the second set of resources (e.g., the set of available resources) due to the overlapping transmission/reception in another carrier if the priority of the data (e.g., LCH) triggering resource allocation is greater than a threshold. Otherwise, the WTRU may not add the resource to the first set of resources (e.g., the set of unavailable resources) and/or exclude the resource from the second set of resources (e.g., the set of available resources). The threshold may be configured or preconfigured per resource pool.

In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the priority of the data (e.g., LCH) triggering resource allocation is smaller than a threshold. Otherwise, the WTRU may not add the resource to the first set of resources (e.g., the set of unavailable resources) and/or exclude the resource from the second set of resources (e.g., the set of available resources). The threshold may be configured or preconfigured per resource pool.

The determination whether to include a resource from a set of unavailable resources, and/or exclude a resource from a set of available resources, may be based on the QoS (e.g., the priority) associated with the overlapping PSCCH/PSSCH and/or PSFCH in another carrier. In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the priority associated with the overlapping PSCCH/PSSCH and/or PSFCH in another carrier is larger than a threshold. Otherwise, the WTRU may not add the resource to the first set of resources (e.g., the set of unavailable resources) and/or exclude the resource from the second set of resources (e.g., the set of available resources). The threshold may be configured or preconfigured per resource pool.

In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the priority associated with the overlapping PSCCH/PSSCH and/or PSFCH in another carrier is smaller than a threshold. Otherwise, the WTRU may not add the resource to the first set of resources (e.g., the set of unavailable resources) and/or exclude the resource from the second set of resources (e.g., the set of available resources). The threshold may be configured or preconfigured per resource pool.

The determination whether to include a resource from a set of unavailable resources, and/or exclude a resource from a set of available resources, may be based on the relative QoS (e.g., priority) between the LCH triggering resource allocation and the overlapping PSCCH/PSSCH and/or PSFCH in another carrier. In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the priority of the LCH triggering resource allocation is greater than the priority of the overlapping PSCCH/PSSCH and/or PSFCH in another carrier. Otherwise, the WTRU may not add the resource to the first set of resources (e.g., the set of unavailable resources) and/or exclude the resource from the second set of resources (e.g., the set of available resources).

In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the priority of the LCH triggering resource allocation is smaller than the priority of the overlapping PSCCH/PSSCH and/or PSFCH in another carrier. Otherwise, the WTRU may not add the resource to the first set of resources (e.g., the set of unavailable resources) and/or exclude the resource from the second set of resources (e.g., the set of available resources).

The determination whether to include a resource from a set of unavailable resources, and/or exclude a resource from a set of available resources, may be based on whether the overlapping resource in another carrier is the transmission or reception resource and/or the type of overlapping channels. Specifically, the WTRU may determine whether to add to the first set of resources (e.g., the set of unavailable resources) and/or exclude from the second set of resources (e.g., the set of available resources) the resources (e.g., PSCCH/PSSCH resource) in the resource allocation window due to the overlapping transmission/reception in another carrier based on one or any combination of the following overlapping scenarios: the PSCCH/PSSCH of the resource allocation carrier overlapping with the PSCCH/PSSCH transmission from another carrier; the PSCCH/PSSCH of the resource allocation carrier overlapping with the PSCCH/PSSCH reception from another carrier; the PSCCH/PSSCH of the resource allocation carrier overlapping with the PSFCH transmission from another carrier; the PSCCH/PSSCH of the resource allocation carrier overlapping with the PSFCH reception from another carrier; the associated PSFCH of the PSCCH/PSSCH of the resource allocation carrier overlapping with the PSCCH/PSSCH transmission from another carrier; the associated PSFCH of the PSCCH/PSSCH of the resource allocation carrier overlapping with the PSCCH/PSSCH reception from another carrier; the associated PSFCH of the PSCCH/PSSCH of the resource allocation carrier overlapping with the PSFCH transmission from another carrier; or the associated PSFCH of the PSCCH/PSSCH of the resource allocation carrier overlapping with the PSFCH reception from another carrier.

The determination whether to include a resource from a set of unavailable resources, and/or exclude a resource from a set of available resources, may be based on whether the carrier of the overlapping resource is an intraband or interband carrier and/or the number of TRX chains of the WTRU. For example, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the two carriers are intraband carriers or the WTRU only has one TRX chain. Otherwise, if the two carriers are inter-band carriers and the WTRU has two TRX chains, the WTRU may not add the resource to the first set of resources (e.g., the set of unavailable resources) and/or exclude the resource from the second set of resources (e.g., the set of available resources).

The determination whether to include a resource from a set of unavailable resources, and/or exclude a resource from a set of available resources, may be based on whether the carrier of the overlapping resource is contiguous or non-contiguous for intraband carrier and/or the number of TRX chains of the WTRU.

The determination whether to include a resource from a set of unavailable resources, and/or exclude a resource from a set of available resources, may be based on whether the band is a full-duplex band or a half-duplex band and/or the number of TRX chains of the WTRU.

The determination whether to include a resource from a set of unavailable resources, and/or exclude a resource from a set of available resources, may be based on the CBR of the resource pool. In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the CBR of the resource pool is greater than a threshold. Otherwise, the WTRU may not add the resource to the first set of resources (e.g., the set of unavailable resources) and/or exclude the resource from the second set of resources (e.g., the set of available resources). The threshold may be configured or preconfigured per resource pool.

In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the CBR of the resource pool is smaller than a threshold. Otherwise, the WTRU may not add the resource to the first set of resources (e.g., the set of unavailable resources) and/or exclude the resource from the second set of resources (e.g., the set of available resources). The threshold may be configured or preconfigured per resource pool.

The determination whether to include a resource from a set of unavailable resources, and/or exclude a resource from a set of available resources, may be based on a measured SL-RSRP of the decoded PSCCH/PSSCH resource. The WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the measured SL-RSRP of the PSCCH/PSSCH reception in another carrier is greater than a threshold. Otherwise, the WTRU may not add the resource to the first set of resources (e.g., the set of unavailable resources) and/or exclude the resource from the second set of resources (e.g., the set of available resources). The threshold may be configured or preconfigured per resource pool.

The determination whether to include a resource from a set of unavailable resources, and/or exclude a resource from a set of available resources, may be based on the type of resource reservation for the overlapping PSCCH/PSSCH resource in another carrier (e.g., whether overlapping PSCCH/PSSCCH and/or its associated PSFCH is reserved semi-persistently or dynamically). In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the overlapping PSCCH/PSSCH or associated PSFCH is reserved semi-persistently. Otherwise, the WTRU may not add the resource to the first set of resources (e.g., the set of unavailable resources) and/or exclude the resource from the second set of resources (e.g., the set of available resources).

In some approaches, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the overlapping PSCCH/PSSCH or associated PSFCH is reserved dynamically. Otherwise, if the overlapping PSCCH/PSSCH or the associated PSFCH is reserved semi-persistently, the WTRU may not add the resource to the first set of resources (e.g., the set of unavailable resources) and/or exclude the resource from the second set of resources (e.g., the set of available resources).

The determination whether to include a resource from a set of unavailable resources, and/or exclude a resource from a set of available resources, may be based on the type of the reserved PSCCH/PSSCH resource (e.g., whether reserved PSCCH/PSSCCH is reserved semi-persistently or dynamically). For example, the WTRU may add the resource (e.g., PSCCH/PSSCH) to the first set of resources (e.g., the set of unavailable resources) and/or exclude the resource from the second set of resources (e.g., the set of available resources) due to the overlapping transmission/reception in another carrier if the overlapping PSCCH/PSSCH or associated PSFCH is reserved dynamically. Otherwise, if the overlapping PSCCH/PSSCH or the associated PSFCH is reserved semi-persistently, the WTRU may not add the resource to the first set of resources (e.g., the set of unavailable resources) and/or exclude the resource from the second set of resources (e.g., the set of available resources).

The determination whether to include a resource from a set of unavailable resources, and/or exclude a resource from a set of available resources, may be based on a number/percentage of resources in the second set of resources (e.g., the set of available resources) after the exclusion procedure. For example, the WTRU may determine whether to add to the first set of resources (e.g., the set of unavailable resources) and/or exclude from the second set of resources (e.g., the set of available resources) the resources (e.g., PSCCH/PSSCH resource) in the resource allocation carrier due to the overlapping transmission/reception in another carrier based on the number of the remaining resources in the second set of resources. Specifically, the WTRU may add the resources (e.g., PSCCH/PSSCH) to the first set of resources (e.g., the set of unavailable resources) and/or exclude the resources from the second set of resources (e.g., the set of available resources) due to the overlapping transmission/reception in another carrier if the number/percentage of resources in the second set of resources after the exclusion procedure is larger than a threshold. Otherwise, if the number/percentage of resources after the exclusion procedure is smaller than a threshold, the WTRU may not add the resource to the first set of resources and/or exclude the resource from the second set of resources. The WTRU may prioritize a certain type of overlapping resources to exclude from the second set of resources until the number/percentage of resources in the second set of resources is greater than the threshold. The threshold may be configured or preconfigured in the resource pool.

In some solutions, a WTRU may perform resource reselection of one resource if it overlaps with the expected Tx/Rx resource in another carrier. In some solutions, the WTRU may perform resource re-evaluation and/or resource pre-emption, in which the resource re-evaluation may be used for the preselected resources and resource pre-emption may be used for the reserved resources. The WTRU may reselect the preselected/reserved resources if the preselected/reserved resources and/or its associated PSFCH resource overlaps with one transmission/reception resource in another carrier, in which the WTRU may not be able to perform one or both of the following: simultaneous transmission in the reserved/selected resource in one carrier and transmission/reception in the overlapping resource in another carrier; or simultaneous reception of PSFCH resource in one carrier and transmission/reception of the overlapping resource in another carrier.

In some sets of solutions, the WTRU may reselect the reserved/preselected resource if it decodes a transmission from another WTRU reserving/scheduling a resource overlapping with the preselected/reserved PSCCH/PSSCH and/or overlapping with the associated PSFCH of the preselected/reserved PSCCH/PSSCH of the WTRU. Specifically, the WTRU may reselect the reserved/preselected PSCCH/PSSCH if it decodes a PSCCH/PSSCH transmission from another WTRU reserving/scheduling a PSCCH/PSSCH and/or PSFCH overlapping with the preselected/reserved PSCCH/PSSCH or overlapping with the associated PSFCH of the preselected/reserved PSCCH/PSSCH of the WTRU in the current resource allocation carrier.

In some solutions, the WTRU determines whether to reselect a reserved/preselected resource. The WTRU may determine whether to reselect the reserved/preselected resource based on one or any combination of the following parameters or conditions.

The determination whether to reselect a reserved/preselected resource may be based on the QoS (e.g., the priority) associated with the preselected/reserved PSCCH/PSSCH resource. For example, the WTRU may determine to reselect the preselected/reserved PSCCH/PSSCH if the priority associated with the resource is smaller than a threshold; otherwise, the WTRU may not reselect the preselected/reserved PSCCH/PSSCH resource.

The determination whether to reselect a reserved/preselected resource may be based on the QoS (e.g., the priority) associated with the overlapping PSCCH/PSSCH and/or PSFCH in another carrier. For example, the WTRU may reselect the preselected/reserved PSCCH/PSSCH if the priority associated with the overlapping PSCCH/PSSCH and/or PSFCH in another carrier is greater than a threshold; otherwise, the WTRU may not reselect the preselected/reserved PSCCH/PSSCH resource.

The determination whether to reselect a reserved/preselected resource may be based on the relative QoS (e.g., priority) between the LCH triggering resource allocation and the overlapping PSCCH/PSSCH and/or PSFCH in another carrier. For example, the WTRU may reselect the preselected/reserved PSCCH/PSSCH if the priority associated with PSCCH/PSSCH resource in the resource allocation carrier is smaller than the priority associated with the overlapping PSCCH/PSSCH and/or PSFCH in another carrier; otherwise, the WTRU may not reselect the preselected/reserved PSCCH/PSSCH resource.

The determination whether to reselect a reserved/preselected resource may be based on whether the overlapping resource in another carrier is the transmission or reception resource and/or the type of overlapping channels. Specifically, the WTRU may determine whether to reselect a preselected/reserved PSCCH/PSSCH resource based on one or any combination of overlapping scenarios as described in the following paragraphs.

The determination whether to reselect a reserved/preselected resource may be based on the preselected/reserved PSCCH/PSSCH of the resource allocation carrier overlapping with a potential PSCCH/PSSCH transmission from another carrier. For example, the WTRU may reselect the preselected/reserved PSCCH/PSSCH of the resource allocation carrier if the priority of the preselected/reserved PSCCH/PSSCH of the resource allocation carrier is smaller than the priority of the potential PSCCH/PSSCH transmission from another carrier.

The determination whether to reselect a reserved/preselected resource may be based on the preselected/reserved PSCCH/PSSCH of the resource allocation carrier overlapping with the PSCCH/PSSCH reception from another carrier. For example, the WTRU may keep the preselected/reserved PSCCH/PSSCH of the resource allocation carrier if the preselected/reserved PSCCH/PSSCH or its associated PSFCH overlaps with a reserved PSCCH/PSSCH transmission from another WTRU in which the WTRU may be one of the target receivers. The WTRU may transmit HARQ NACK to request the other WTRU to retransmit the TB.

The determination whether to reselect a reserved/preselected resource may be based on the preselected/reserved PSCCH/PSSCH of the resource allocation carrier overlapping with the PSFCH transmission from another carrier. For example, the WTRU may keep the preselected/reserved PSCCH/PSSCH of the resource allocation carrier if the preselected/reserved PSCCH/PSSCH is overlapping with its PSFCH transmission in another carrier. Specifically, the WTRU may perform rate-matching/puncturing of the overlapping symbols of the PSCCH/PSSCH between two resources if the WTRU cannot perform simultaneous transmission in two carriers.

The determination whether to reselect a reserved/preselected resource may be based on the PSCCH/PSSCH of the resource allocation carrier overlapping with the PSFCH reception from another carrier. For example, the WTRU may keep the preselected/reserved PSCCH/PSSCH of the resource allocation carrier if the preselected/reserved PSCCH/PSSCH is overlapping with its PSFCH transmission in another carrier. Specifically, the WTRU may perform rate-matching/puncturing of the overlapping symbols of the PSCCH/PSSCH between two resources if the WTRU cannot perform simultaneous transmission in PSCCH/PSSCH and reception in PSFCH in two carriers.

The determination whether to reselect a reserved/preselected resource may be based on the associated PSFCH of the PSCCH/PSSCH of the resource allocation carrier overlapping with the PSCCH/PSSCH transmission from another carrier. For example, the WTRU may keep the preselected/reserved PSCCH/PSSCH of the resource allocation carrier if the associated PSFCH of the preselected/reserved PSCCH/PSSCH is overlapping with the PSCCH/PSSCH transmission in another carrier. Specifically, the WTRU may perform rate-matching/puncturing of the overlapping symbols of the PSCCH/PSSCH between two resources if the WTRU cannot perform simultaneous transmission in PSCCH/PSSCH and reception of PSFCH in two carriers.

The determination whether to reselect a reserved/preselected resource may be based on the associated PSFCH of the PSCCH/PSSCH of the resource allocation carrier overlapping with the PSCCH/PSSCH reception from another carrier. For example, the WTRU may keep the preselected/reserved PSCCH/PSSCH of the resource allocation carrier if the associated PSFCH of the preselected/reserved PSCCH/PSSCH is overlapping with a PSCCH/PSSCH transmission in another carrier. Specifically, the WTRU may perform rate-matching/puncturing of the overlapping symbols of the PSCCH/PSSCH between two resources if the WTRU cannot perform simultaneous transmission in PSCCH/PSSCH and reception of PSFCH in two carriers.

The determination whether to reselect a reserved/preselected resource may be based on the associated PSFCH of the PSCCH/PSSCH of the resource allocation carrier overlapping with the PSFCH transmission from another carrier. For example, the WTRU may reselect the preselected/reserved PSCCH/PSSCH of the resource allocation carrier if the associated PSFCH of the preselected/reserved PSCCH/PSSCH is overlapping with a PSFCH transmission from another carrier. The WTRU may reselect the preselected/reserved PSCCH/PSSCH if the priority of the PSCCH/PSSCH is smaller than the priority of the overlapping PSFCH in another carrier.

The determination whether to reselect a reserved/preselected resource may be based on the associated PSFCH of the PSCCH/PSSCH of the resource allocation carrier overlapping with the PSFCH reception from another carrier. For example, the WTRU may keep the preselected/reserved PSCCH/PSSCH of the resource allocation carrier if the associated PSFCH of the preselected/reserved PSCCH/PSSCH is overlapping with the PSFCH reception from another carrier.

The determination whether to reselect a reserved/preselected resource may be based on whether the carrier of the overlapping resource is intraband or interband carriers and/or the number of TRX chains of the WTRU.

The determination whether to reselect a reserved/preselected resource may be based on whether the carrier of the overlapping resource is contiguous or non-contiguous for intraband carrier and/or the number of TRX chains of the WTRU.

The determination whether to reselect a reserved/preselected resource may be based on whether the band is a full-duplex or half-duplex band and/or the number of TRX chains of the WTRU.

The determination whether to reselect a reserved/preselected resource may be based on a CBR of the resource pool. In some approaches, the WTRU may reselect the preselected/reserved PSCCH/PSSCH resource if the CBR of the resource pool is greater than a threshold. Otherwise, the WTRU may keep the preselected/reserved PSCCH/PSSCH resource. The threshold may be configured or preconfigured in the resource pool. In some approaches, the WTRU may reselect the preselected/reserved PSCCH/PSSCH resource if the CBR of the resource pool is greater than a threshold. Otherwise, the WTRU may keep the preselected/reserved PSCCH/PSSCH resource. The threshold may be configured or preconfigured in the resource pool.

The determination whether to reselect a reserved/preselected resource may be based on a measured SL-RSRP of the decoded PSCCH/PSSCH resource. For example, the WTRU may reselect the preselected/reserved PSCCH/PSSCH resource in the current resource allocation carrier if the measured SL-RSRP of the PSCCH/PSSCH reception in another carrier is greater than a threshold. Otherwise, the WTRU may keep the preselected/reserved PSCCH/PSSCH resource in the current resource allocation carrier. The threshold may be configured or preconfigured per resource pool.

The determination whether to reselect a reserved/preselected resource may be based on a HARQ type of the TB and/or HARQ type of the overlapping resource in another carrier. For example, the WTRU may reselect the preselected/reserved PSCCH/PSSCH for one HARQ type (e.g., HARQ disabled) of the TB and/or the overlapping resource. The WTRU may not reselect the preselected/reserved PSCCH/PSSCH for another HARQ type (e.g., HARQ disabled) of the TB and/or of the overlapping resource.

The determination whether to reselect a reserved/preselected resource may be based on a cast type of the TB and/or cast type of the overlapping resource in another carrier. For example, the WTRU may reselect the preselected/reserved PSCCH/PSSCH for one cast type (e.g., unicast) of the TB and/or the overlapping resource. The WTRU may not reselect the preselected/reserved PSCCH/PSSCH for another cast type (e.g., broadcast) of the TB and/or of the overlapping resource.

The determination whether to reselect a reserved/preselected resource may be based on whether the WTRU is the receiver of the decoded PSCCH/PSSCH. For example, the WTRU may reselect the preselected/reserved PSCCH/PSSCH resource in the current resource allocation carrier if the WTRU is the receiver of the overlapping transmission resource in another carrier. Otherwise, the WTRU may keep the preselected/reserved PSCCH/PSSCH resource.

The determination whether to reselect a reserved/preselected resource may be based on whether the transmitter/receiver WTRU in the overlapping resource is the target receiver of the preselected/reserved PSCCH/PSSCH resource. For example, the WTRU may reselect the preselected/reserved PSCCH/PSSCH resource in the current resource allocation carrier if the transmitter/receiver of the overlapping resource in another carrier is the target WTRU of the preselected/reserved PSCCH/PSSCH resource.

The determination whether to reselect a reserved/preselected resource may be based on whether the PSCCH/PSSCH resource is a preselected or reserved resource.

The determination whether to reselect a reserved/preselected resource may be based on the type of resource reservation for the overlapping PSCCH/PSSCH resource the other carrier (e.g., whether overlapping PSCCH/PSSCCH and/or its associated PSFCH is reserved semi-persistently or dynamically). In some approaches, the WTRU may reselect the preselected/reserved PSCCH/PSSCH resource if the overlapping PSCCH/PSSCH or associated PSFCH in another carrier is reserved semi-persistently. Otherwise, the WTRU may keep the preselected/reserved PSCCH/PSSCH resource. In some approaches, the WTRU may reselect the preselected/reserved PSCCH/PSSCH resource if the overlapping PSCCH/PSSCH or associated PSFCH in another carrier is reserved dynamically. Otherwise, the WTRU may keep the preselected/reserved PSCCH/PSSCH resource.

The determination whether to reselect a reserved/preselected resource may be based on the traffic type and/or the resource reservation type for the preselected/reserved PSCCH/PSSCH resource in the resource allocation carrier (e.g., whether the preselected/reserved resource is reserved/selected for periodic reservation or aperiodic reservation). In some approaches, the WTRU may reselect the preselected/reserved PSCCH/PSSCH resource if it is reserved periodically. Otherwise, the WTRU may keep the preselected/reserved PSCCH/PSSCH resource. In some approaches, the WTRU may keep the preselected/reserved PSCCH/PSSCH resource if it is reserved periodically. Otherwise, the WTRU may reselect the preselected/reserved PSCCH/PSSCH resource.

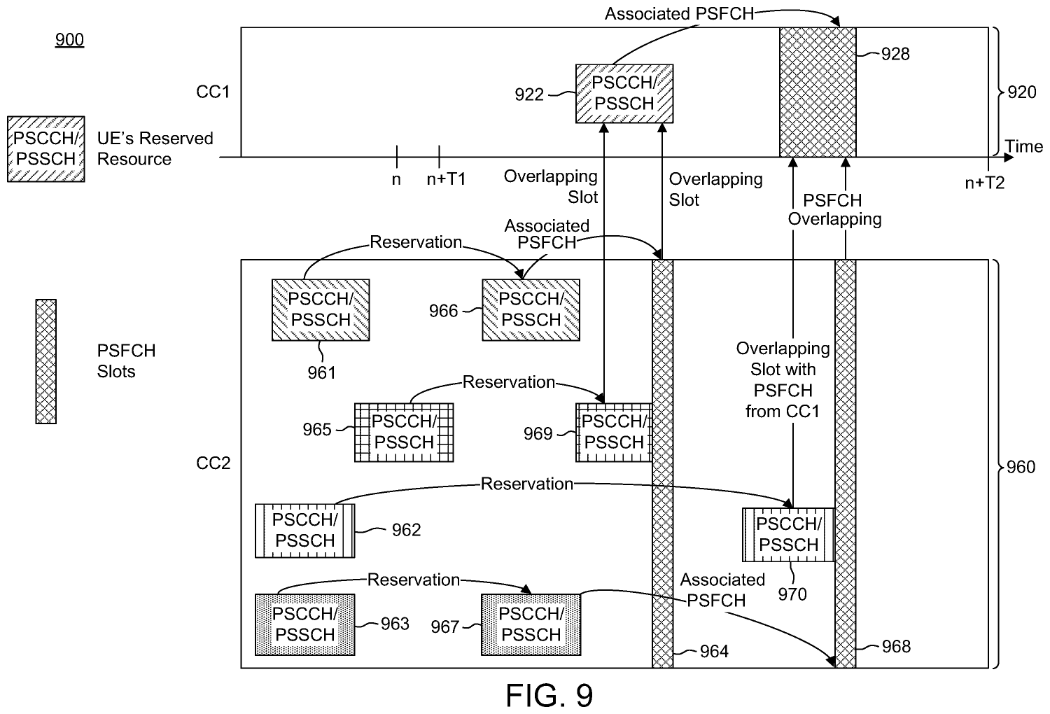

FIG. 9 is a resource diagram illustrating an example of a WTRU performing resource reselection when the PSCCH/PSSCH resources and/or its associated PSFCH resources overlap with the reception resources in another carrier. As shown in resource diagram 900, the WTRU may determine to reselect the preselected/reserved resource based on one or any combination of the following events. The WTRU may make the determination based on the reception of a PSCCH/PSSCH transmission, on PSCCH/PSSCH resources 961, which reserves other PSCCH/PSSCH resources 966 having associated PSFCH resources 964 overlapping with the preselected/reserved PSCCH/PSSCH resources 922 of the WTRU. The PSCCH/PSSCH transmission may be received on a first component carrier, such as CC1 920. As in other examples, n may be a resource selection or resource reselection triggering slot. Also, n+T1 may be the first slot of the resource selection window. Further, n+T2 may be the last slot of the resource selection window.

Further, the WTRU may make the determination based on the reception of a PSCCH/PSSCH transmission, on PSCCH/PSSCH resources 965, which reserves other PSCCH/PSSCH resources 969 overlapping with the preselected/reserved PSCCH/PSSCH resources 922 of the WTRU. The PSCCH/PSSCH transmission received on PSCCH/PSSCH resources 965 may be received on a second component carrier, such as CC2 960.

Also, the WTRU may make the determination based on the reception of a PSCCH/PSSCH transmission, on PSCCH/PSSCH resources 962, which reserves other PSCCH/PSSCH resources 970 overlapping with the associated PSFCH resources 928 of the preselected/reserved PSCCH/PSSCH resources 922 of the WTRU. Additionally, or alternatively, the WTRU may make the determination based on the reception of a PSCCH/PSSCH transmission, on PSCCH/PSSCH resources 963, which reserves other PSCCH/PSSCH resources 967 having associated PSFCH resources 968 overlapping with the associated PSFCH resources 928 of the preselected/reserved PSCCH/PSSCH resources 922 of the WTRU.

In some solutions, a WTRU may indicate resource collision to the WTRU reserving the colliding resource. The WTRU may transmit IUC (e.g., a collision indication) to the WTRU reserving the colliding resource to implicitly request the WTRU to perform resource selection.

In some solutions, a WTRU may perform a logical channel prioritization (LCP) procedure. For instance, the WTRU may perform LCP restriction to determine whether to multiplex a HARQ enabled LCH to the TB or not. Specifically, if the associated PSFCH of the PSCCH/PSSCH resource is overlapping with another transmission/reception of the WTRU in another carrier, in which the WTRU may not be able to perform simultaneous reception of the associated PSFCH in the current carrier and transmission/reception in the resource in another carrier, the WTRU may determine to multiplex the LCH with HARQ disabled to construct the TB for potential transmission in PSCCH/PSSCH of the current carrier.

In some solutions, a WTRU may determine whether to perform resource reselection or other prioritization methods. The WTRU may determine whether to perform resource reselection or other prioritization methods (e.g., resource dropping, rate-matching/puncturing, performing transmission/reception only) based on the time gap between the detection time/slot of the resource overlapping event and actual resource overlapping slot or the transmission reserving/scheduling the resource in the overlapping slot. Specifically, if the time gap between the detection time of resource overlapping event and the resource overlapping slot or the transmission slot reserving/scheduling the resource in the overlapping is larger than a threshold, the WTRU may perform resource reselection. Otherwise, if the time gap is smaller than a threshold, the WTRU may perform other prioritization method(s) (e.g., resource dropping, rate-matching/puncturing, performing transmission/reception only). The threshold may be configured or preconfigured in the resource pool. It may be determined based on the processing capability of the WTRU.

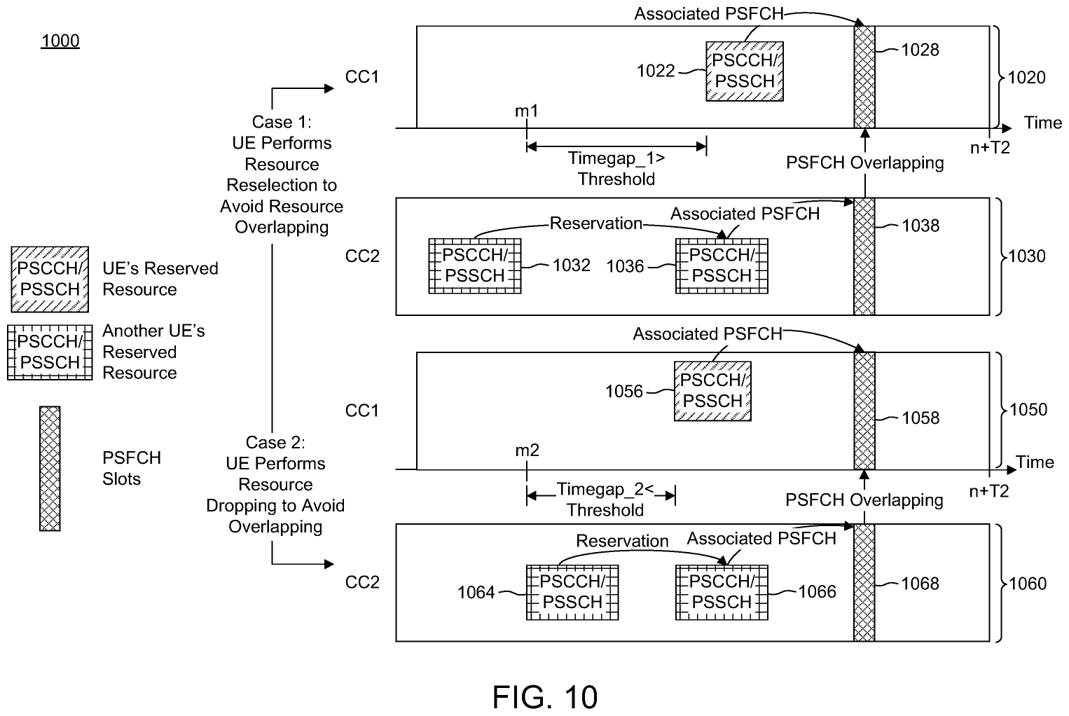

FIG. 10 is a resource diagram illustrating example scenarios in which a WTRU determines whether to perform resource reselection or other prioritization methods due to resources overlapping in different carriers. In one example shown in resource diagram 1000, the WTRU may determine whether to perform resource reselection or other resource prioritization methods (e.g., dropping transmission/reception resource, rate-matching/puncturing, and the like) based on the time gap between the detection of the overlapping event and the resource overlapping slot. In an example in FIG. 10, n+T2 may be the last slot of the resource selection window.

Specifically, in examples shown case 1 in FIG. 10, the WTRU may determine that the time gap between the detection of the overlapping event and the PSCCH/PSSCH resources 1022, 1036 scheduling the overlapping PSFCH slots 1028, 1038, for example, Timegap_1, is larger than the threshold. Accordingly, the WTRU may determine to perform resource reselection. The WTRU may then perform resource reselection. As a result, the WTRU may perform resource reselection to avoid resource overlapping. In CC2 1030, a PSCCH/PSSCH transmission 1032 may schedule PSCCH/PSSCH resources 1036, which in turn may be used by a PSCCH/PSSCH transmission associated with PSFCH resources 1038. Further, in CC1 1020, PSCCH/PSSCH resources 1022 may be used by a PSCCH/PSSCH transmission associated with PSFCH resources 1028. In an example, the WTRU may detect the overlapping event at time m1, at the beginning of Timegap_1. Further, Timegap_1 may end at the beginning of PSCCH/PSSCH resources 1022, which is also the beginning of the PSCCH/PSSCH transmission associated with overlapping PSFCH resources 1028.

However, for case 2, the WTRU may determine that the time gap between the detection of the overlapping event and the PSCCH/PSSCH scheduling the overlapping slots (i.e., Timegap_2) is smaller than the threshold. Accordingly, the WTRU may determine to perform resource dropping. As a result, the WTRU may then perform resource dropping. In CC2 1060, a PSCCH/PSSCH transmission 1064 may schedule PSCCH/PSSCH resources 1066, which in turn may be used by a PSCCH/PSSCH transmission associated with PSFCH resources 1068. Further, in CC1 1050, PSCCH/PSSCH resources 1056 may be used by a PSCCH/PSSCH transmission associated with PSFCH resources 1058. In an example, the WTRU may detect the overlapping event at time m2, at the beginning of Timegap_2. Further, Timegap_2 may end at the beginning of PSCCH/PSSCH resources 1056, which is also the beginning of the PSCCH/PSSCH transmission associated with overlapping PSFCH resources 1058.

In some solutions, a WTRU may trigger a resource overlapping detection event. The WTRU may trigger resource overlapping detection to reduce potential resource overlapping collisions. Specifically, the WTRU may determine to trigger resource overlapping detection for each preselected/reserved resource at least a period before the preselected/reserved resource. The WTRU may then reselect the preselected/reserved resource if the overlapping event is detected.

Resource synchronization procedures are described herein. In some procedures, a WTRU may perform sidelink synchronization transmissions. A WTRU may determine to perform sidelink synchronization signal (SLSS) transmissions to be a synchronization reference WTRU (SynRef WTRU). The WTRU may perform transmission of S-PSS, S-SSS, and/or PBSCH for another WTRU to synchronize sidelink transmission and/or reception. Herein the transmission of one or any combination of the signals (e.g., S-PSS, S-SSS, PBSCH) may be referred to as SLSSs.

A WTRU may determine the carrier(s) on which to transmit SLSS. In some solutions, the WTRU may determine which carrier(s) to transmit SLSS based on one or any combination of example factors as may be described in the following paragraphs.

The WTRU may determine which carrier(s) to transmit SLSS based on the service established at the WTRU. For example, the WTRU may be configured or preconfigured a set of carriers for one sidelink service. The WTRU may then perform SLSS transmission in the carrier associated with the established service at the WTRU.

In another example of the service established at the WTRU, the WTRU may be configured or preconfigured with one or more sidelink services, in which each service may be associated with one or more carriers. For one sidelink service, the WTRU may then determine to perform SLSS transmission in at least one carrier configured or preconfigured for each service.

The WTRU may determine which carrier(s) to transmit SLSS based on the reception of SLSS. For example, the WTRU may determine to synchronize to one node (e.g., one WTRU). The WTRU may receive synchronization a signal from the WTRU. The WTRU may transmit SLSS in the carrier it receives SLSS from another node. In an example, the another node may be a base station, gNB, SynRef WTRU, an SL WTRU, a peer WTRU, a relay WTRU, another WTRU or the like.

The WTRU may determine which carrier(s) to transmit SLSS based on the SCS of the carrier. In an example where the WTRU may determine which carrier to transmit SLSS based on the SCS of the carrier, the WTRU may be configured or preconfigured a set of carriers for CA. For each configured or preconfigured SCS, the WTRU may perform SLSS transmission in at least one carrier. In some examples, the WTRU may determine to perform SLSS transmission in the carrier having the lowest SCS in the set carriers configured or preconfigured for CA. In some examples, the WTRU may determine to perform SLSS transmission in the carrier having the highest SCS in the set of carriers configured or preconfigured for CA.

The WTRU may determine which carrier(s) to transmit SLSS based on the number of synchronization occasions per synchronization period. In some examples, the WTRU may perform SLSS transmission in the carrier having the highest number of SLSS occasions in a synchronization period. In some examples, the WTRU may perform SLSS transmission in the carrier having the smallest number of SLSS occasions in a synchronization period.

The WTRU may determine which carrier(s) to transmit SLSS based on the type of carrier, which may include one or any combination of the following: the carrier preconfigured to the WTRU; the carrier shared with Uu; and/or the carrier indicated by the network. In an example, the carrier preconfigured to the WTRU may be an intelligent transport systems (ITS) carrier.

The WTRU may determine which carrier(s) to transmit SLSS based on the type of carrier used with the Uu. For example, the WTRU may prioritize transmitting SLSS in a non-shared carrier with Uu.

In some solutions, a WTRU determines the synchronization occasion in which to transmit sidelink synchronization signals. For instance, in some solutions, the WTRU may determine which SLSS occasion to transmit SLSS in one carrier based on the configured or preconfigured SLSS occasion from other carriers. In some approaches, the WTRU may prioritize transmitting SLSS in the synchronization occasion having fewer numbers of overlapping configured SLSS resources from other carriers. This approach may be motivated to reduce the power-sharing for SLSS transmission among carriers.

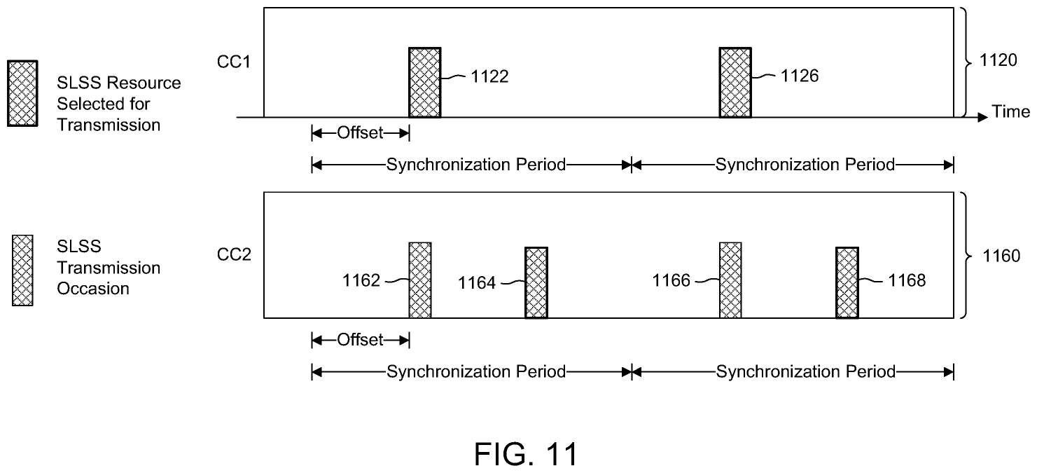

FIG. 11 is a resource diagram illustrating an example scenario of a WTRU determining the SLSS occasion in which to transmit an SLSS. In an example as shown in resource diagram 1100, the WTRU may be configured or preconfigured with two carriers to transmit SLSS, in which the synchronization periodicity and offset are identical between two carriers. The WTRU may be configured or preconfigured one SLSS occasion per synchronization period for CC1 1120 and two SLSS occasions per synchronization period for CC2 1160. For example, the WTRU may be configured or preconfigured with SLSS occasion 1122 for a first synchronization period, and with SLSS occasion 1126 for a second synchronization period. Further, the WTRU may be configured or preconfigured with SLSS occasions 1162, 1164 for the first synchronization period, and with SLSS occasions 1166, 1168 for the second synchronization period. For CC2 1160, the WTRU may select a SLSS resource not overlapping with selected SLSS resources on CC1 1120 to transmit SLSS. For example, since the WTRU selected SLSS resources 1122, 1126 on CC1 1120, for CC2 1160, the WTRU may select SLSS resources 1164, 1668, which are not overlapping with selected SLSS resources 1122, 1126.

In some approaches, the WTRU may transmit multiple SLSSs in the SLSS occasions configured or preconfigured in the carrier. The WTRU may determine the number of SLSS occasions to transmit based on the number of configured SLSS occasions and the transmission status of SLSS on the other occasion. Specifically, the WTRU may determine to transmit N SLSSs in one carrier per synchronization period. The WTRU may then increase the number of SLSSs to transmit if one or more SLSS is deprioritized. This may occur, for example, if the transmission power of SLSS in one carrier is reduced.

In some solutions, a WTRU may determine whether to perform SLSS transmission in N carriers simultaneously. For instance, the WTRU may determine whether to perform SLSS transmission in N carriers simultaneously, in which N carriers may be configured or preconfigured for carrier aggregation. In some approaches, the WTRU may determine not to transmit SLSS in all N carriers if the transmission in N carrier requires power reduction in one or more prioritized carriers. Specifically, the WTRU may be configured or preconfigured with SLSS transmission priority for each carrier. The WTRU may then calculate the transmission power of SLSS for each carrier. The WTRU may then determine whether to transmit SLSS in one carrier based on whether the WTRU needs to reduce the transmission power of SLSS in another carrier (e.g., a carrier with higher SLSS priority). Specifically, if the transmission of SLSS may result in a power reduction of SLSS in one or more prioritized SLSSs, the WTRU may determine to reduce the transmission power of the non-prioritized SLSS or drop the non-prioritized one.

In some solutions, a WTRU may perform prioritization between SLSS in different carriers. For instance, in some solutions, the WTRU may be configured or preconfigured to potentially perform SLSS transmission in one or more carriers. The WTRU may determine which carrier to prioritize based on one or any combination of example parameters as may be described in the following paragraphs.

The WTRU may determine which carrier to prioritize based on a priority associated with the carrier. For example, the WTRU may be configured or preconfigured with the prioritization of the SLSS resource associated with each carrier. The WTRU may then determine which SLSS is prioritized based on the priority configured or preconfigured for the carrier.

The WTRU may determine which carrier to prioritize based on the received SLSS carrier. For example, the WTRU may prioritize the SLSS transmission in the carrier the WTRU received SLSS to reference the synchronization of the SLSS transmission.

The WTRU may determine which carrier to prioritize based on a SCS associated with the carrier. In some examples, the WTRU may prioritize SLSS transmission of the carrier with lower SCS. In some examples, the WTRU may prioritize SLSS transmission of the carrier with higher SCS.

The WTRU may determine which carrier to prioritize based on the number of SLSS occasions within a synchronization period configured in the carrier. In some examples, the WTRU may prioritize SLSS transmission of the carrier having a higher number of synchronization occasions per synchronization period. In some examples, the WTRU may prioritize SLSS transmission of the carrier having a lower number of synchronization occasions per synchronization period. In some examples, the WTRU may be configured or preconfigured to prioritize which carrier based on the SCS of the carrier (e.g., the carrier having larger or smaller SCS). The WTRU may then determine which carrier to prioritize based on the SCS associated with the carrier and the configured or preconfigured prioritization rule.

The WTRU may determine which carrier to prioritize based on the transmission power associated with one or more carriers. In some examples, the WTRU may prioritize the SLSS with higher transmission power. In some examples, the WTRU may prioritize the SLSS with lower transmission power.

The WTRU may determine which carrier to prioritize based on the type of carrier, which may include one or any combination of the following: the carrier preconfigured to the WTRU (e.g., ITS carrier); the carrier shared with Uu; and/or the carrier indicated by the network. In some examples, the WTRU may prioritize the SLSS associated with the non-shared carrier with Uu. In some examples, the WTRU may prioritize the SLSS associated with the shared carrier with Uu.

In some solutions, a WTRU may trigger sidelink synchronization signal transmission in another carrier based on an indication from a peer WTRU. For instance, in some solutions, the WTRU may determine to trigger SLSS transmission/reception in another carrier based on the indication from another WTRU. Specifically, the WTRU may have an unicast/groupcast connection with other WTRU(s). In one approach, the WTRU may indicate to other WTRU(s) to establish unicast/groupcast session in another carrier. The WTRU may then trigger SLSS transmission/reception in the carrier. In another approach, the WTRU may receive an indication from other WTRU(s) to establish unicast/groupcast session in another carrier. The WTRU may then trigger SLSS transmission/reception in the carrier. The WTRU may transmit/receive the unicast/groupcast establishment in another carrier using PC5 radio resource control (RRC) signaling, a MAC control element (CE), or SCI, or any logically equivalent signal or message thereof.

Embodiments, features and elements described above may be considered to include means for performing the methods and procedures described in examples above. The means may include those known to one of ordinary skill in the art.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
determining:
to one of transmit or receive a first sidelink (SL) transmission using first SL resources using a first carrier, and
to transmit a second SL transmission using second SL resources using a second carrier, wherein the second SL resources include an overlapping period, and wherein the second SL resources overlap with the first SL resources in the overlapping period;
on a condition that the overlapping period is in last one or more symbols of the second SL resources, transmitting, using the second carrier, at least part of the second SL transmission in a first set of symbols of the second SL resources in the overlapping period and not transmitting, using the second carrier, in a second set of symbols of the second SL resources in the overlapping period;
transmitting, to a reception WTRU, information regarding the first set of symbols of the second SL resources and the second set of symbols of the second SL resources in sidelink control information (SCI); and
one of transmitting or receiving, using the first carrier, the first SL transmission using the first SL resources in the overlapping period.

2. The method of claim 1, wherein the first SL resources include first time resources, wherein the second SL resources include second time resources, and wherein the overlapping period is in one or more symbols of the second time resources which overlap in time with one or more symbols of the first time resources.

3. The method of claim 1, wherein the first SL transmission is a physical sidelink feedback channel (PSFCH) transmission; and wherein the first SL resources are PSFCH resources.

4. The method of claim 1, wherein the second SL transmission is any one of a physical sidelink control channel (PSCCH) transmission, a physical sidelink shared channel (PSSCH) transmission, or a combination of a PSCCH transmission and a PSSCH transmission; and wherein the second SL resources are any one of PSCCH resources, PSSCH resources, or a combination of PSCCH resources and PSSCH resources.

5. The method of claim 1, wherein the transmitting, using the second carrier, at least part of the second SL transmission in a first set of symbols of the second SL resources in the overlapping period and not transmitting, using the second carrier, in a second set of symbols of the second SL resources in the overlapping period is puncturing.

6. The method of claim 1, wherein the transmitting, using the second carrier, at least part of the second SL transmission in a first set of symbols of the second SL resources in the overlapping period and not transmitting, using the second carrier, in a second set of symbols of the second SL resources in the overlapping period is rate matching.

7. The method of claim 1, further comprising:
on a condition that the overlapping period is earlier than the last one or more symbols of the second SL resources, one of dropping one of the transmission or the reception of the first SL transmission, or dropping the transmission of the second SL transmission, based on a comparison of a priority associated with the first SL resources with a priority associated with the second SL resources.

8. (canceled)

9. The method of claim 1, further comprising:
receiving an SL grant of resources for transmitting the second SL transmission using the second carrier.

10. The method of claim 1, further comprising:
selecting resources for transmitting the second SL transmission using the second carrier.

11. A wireless transmit/receive unit (WTRU) comprising:
a processor; and
a transceiver operatively coupled to the processor; wherein:
the processor is configured to determine:
to one of transmit or receive a first sidelink (SL) transmission using first SL resources using a first carrier, and
to transmit a second SL transmission using second SL resources using a second carrier, wherein the second SL resources include an overlapping period, and wherein the second SL resources overlap with the first SL resources in the overlapping period;
the transceiver is configured to transmit, on a condition that the overlapping period is in last one or more symbols of the second SL resources, using the second carrier, at least part of the second SL transmission in a first set of symbols of the second SL resources in the overlapping period and not transmit, using the second carrier, in a second set of symbols of the second SL resources in the overlapping period;
the transceiver is further configured to transmit, to a reception WTRU, information regarding the first set of symbols of the second SL resources and the second set of symbols of the second SL resources in sidelink control information (SCI); and
the transceiver is configured to one of transmit or receive, using the first carrier, the first SL transmission using the first SL resources in the overlapping period.

12. The WTRU of claim 11, wherein the first SL resources include first time resources, wherein the second SL resources include second time resources, and wherein the overlapping period is in one or more symbols of the second time resources which overlap in time with one or more symbols of the first time resources.

13. The WTRU of claim 11, wherein the first SL transmission is a physical sidelink feedback channel (PSFCH) transmission; and wherein the first SL resources are PSFCH resources.

14. The WTRU of claim 11, wherein the second SL transmission is any one of a physical sidelink control channel (PSCCH) transmission, a physical sidelink shared channel (PSSCH) transmission, or a combination of a PSCCH transmission and a PSSCH transmission; and wherein the second SL resources are any one of PSCCH resources, PSSCH resources, or a combination of PSCCH resources and PSSCH resources.

15. The WTRU of claim 11, wherein the transmitting, using the second carrier, at least part of the second SL transmission in a first set of symbols of the second SL resources in the overlapping period and not transmitting, using the second carrier, in a second set of symbols of the second SL resources in the overlapping period is puncturing.

16. The WTRU of claim 11, wherein the transmitting, using the second carrier, at least part of the second SL transmission in a first set of symbols of the second SL resources in the overlapping period and not transmitting, using the second carrier, in a second set of symbols of the second SL resources in the overlapping period is rate matching.

17. The WTRU of claim 11, wherein the transceiver is further configured to one of, on a condition that the overlapping period is earlier than the last one or more symbols of the second SL resources, dropping one of the transmission or the reception of the first SL transmission, or dropping the transmission of the second SL transmission, based on a comparison of a priority associated with the first SL resources with a priority associated with the second SL resources.

18. (canceled)

19. The WTRU of claim 11, wherein the transceiver is further configured to receive an SL grant of resources for transmitting the second SL transmission using the second carrier.

20. The WTRU of claim 11, wherein the processor is further configured to select resources for transmitting the second SL transmission using the second carrier.
